(19) United States
(12) Patent Application Publication
(10) Pub. No.: US 2026/0143103 A1
(43) Pub. Date: May 21, 2026

(54) FULL RANGE IMAGE SENSOR PROFILING SYSTEM

(71) Applicant: Mobileye Vision Technologies Ltd., Jerusalem (IL)

(72) Inventor: Gabriel Bowers, Boulogne-Billancourt (FR)

(73) Assignee: Mobileye Vision Technologies Ltd., Jerusalem (IL)

(21) Appl. No.: 19/250,678

(22) Filed: Jun. 26, 2025

Related U.S. Application Data
(60) Provisional application No. 63/646,156, filed on May 13, 2024.
(60) Provisional application No. 63/723,195, filed on Nov. 21, 2024.
(60) Provisional application No. 63/787,102, filed on Apr. 11, 2025.

(30) Foreign Application Priority Data
May 12, 2025 (NL) 2040346

(51) Int. Cl. H04N 17/00; G06V 10/141; G06V 10/147; G06V 10/56; G06V 10/60; G06V 10/96; G06V 20/56; H04N 23/73; H04N 23/74

(52) U.S. Cl. CPC H04N 17/002; G06V 10/141; G06V 10/147; G06V 10/56; G06V 10/60; G06V 10/96; G06V 20/56; H04N 23/73; H04N 23/74

(57) ABSTRACT

Techniques are disclosed for performing an image sensor profiling process and accompanying architecture that facilitates performing an image quality measurement over a range of different parameters such as light levels, exposure values, contrast targets, confidence intervals, color ratios, temperature, etc. An image sensor profile may then be generated from these measurements includes an image sensor performance profile dataset. This dataset provides contrast detection probability (CDP) measurement data over a full range of operating parameters of the image sensor. The image sensor performance profile dataset may quantify the image quality and performance for a full range of operation. The image sensor performance profile dataset may be implemented to generate an image sensor model, which may be deployed in a vehicle and used to modify the functions thereof during operation.

### CROSS-REFERENCE TO RELATED APPLICATIONS

This application claims priority to U.S. provisional application no. 63/646,156, filed on May 13, 2024, U.S. provisional application no. 63/723,195, filed on Nov. 21, 2024, U.S. provisional application no. 63/787,102, filed on Apr. 11, 2025, and Netherlands application no. 2040346, filed May 12, 2025, the contents of each of which are incorporated herein by reference in their entireties.

### TECHNICAL FIELD

Aspects described herein generally relate to performing an image sensor profiling process and, in particular to performing an image sensor profiling to measure image sensor performance over a range of different parameters, which may be implemented to generate an image sensor model that is deployed in a vehicle and used to modify the functions thereof during operation.

### BACKGROUND

Conventional image sensor testing, which is done to verify image quality, typically requires a significant amount of data to be collected in the form of the analysis of images acquired over time and under various conditions. Thus, for vehicle-based applications, such testing may require images and/or videos to be collected over several days or weeks while driving during the day, at night, driving thorough tunnels, etc. Once a large enough set of image data is acquired in this manner, a manual process is typically implemented in which a user reviews the images to identify quality-related issues. This process is not only arduous and time-consuming, but often fails to identify quality issues for the images under all operating parameters, as the image data collection process essentially samples sets of images over random (but not all possible) operating conditions. Thus, the current means by which image sensors are evaluated with respect to their quality has various drawbacks and fails to provide a robust and complete evaluation of the image sensor.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

FIG. 1 illustrates an example vehicle in accordance with one or more aspects of the present disclosure.

FIG. 2 illustrates various example electronic components of a safety system of a vehicle in accordance with one or more aspects of the present disclosure;

FIG. 3 illustrates an example architecture for generating a full range image sensor performance profile dataset, in accordance with one or more aspects of the present disclosure;

FIG. 4 illustrates an example test pattern used for generating a full range image sensor performance profile dataset, in accordance with one or more aspects of the present disclosure;

FIG. 5 illustrates an example process flow, in accordance with one or more aspects of the present disclosure;

FIGS. 6A-6B illustrate example performance plots that are derived from the image sensor performance profile dataset, in accordance with one or more aspects of the present disclosure;

FIGS. 7A-7C illustrate example plots of contrast detection probability (CDP) versus light range for different contrast targets, in accordance with one or more aspects of the present disclosure;

FIG. 8 illustrates an example CDP versus light level plot and a 2D heatmap that maps the CDP values represented in the image sensor performance profile dataset across a set of different light levels and exposure values, in accordance with one or more aspects of the present disclosure;

FIGS. 9A-9B illustrate example 2D CDP heatmaps that plot a probability of a specified contrast detection within a specified confidence interval over a range of exposure values and light levels for two different image sensors, in accordance with one or more aspects of the present disclosure;

FIGS. 10A and 10B illustrate example plots that are generated from the image sensor performance profile dataset of a sensor to determine low light performance, in accordance with one or more aspects of the present disclosure;

FIGS. 11A and 11B illustrate example plots for the two different image sensors corresponding to the 2D CDP heatmaps of FIGS. 9A and 9B, in accordance with one or more aspects of the present disclosure;

FIGS. 12A-12B illustrate example 2D heatmaps representing a mapping of color ratio values over a range of exposure values and light levels, in accordance with one or more aspects of the present disclosure; and

FIGS. 13A-13B illustrate example sets of 2D heatmaps representing different color ratio value mappings for a range of exposure values and a range of light levels, which correspond to the two different image sensors of the 2D CDP heatmaps of FIGS. 9A and 9B, in accordance with one or more aspects of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

### I. An Example Vehicle Architecture

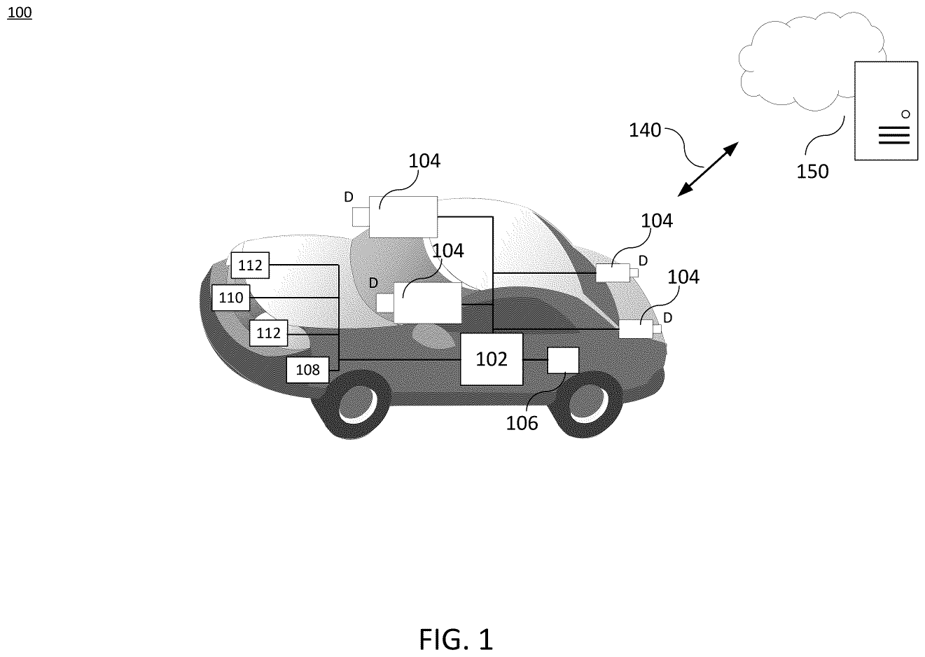

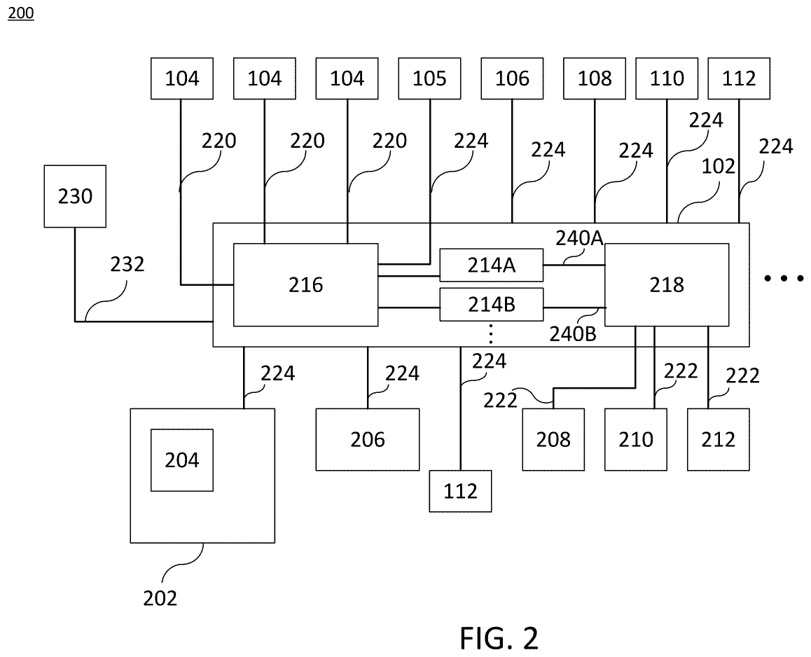

FIG. 1 shows a vehicle 100 including a safety system 200 (see also FIG. 2) in accordance with various aspects of the present disclosure. The vehicle 100 and the safety system 200 are exemplary in nature, and may thus be simplified for explanatory purposes. Locations of elements and relational distances (as discussed herein, the Figures are not to scale) and are provided by way of example and not limitation. The safety system 200 may include various components depending on the requirements of a particular implementation and/or application, and may facilitate the navigation and/or control of the vehicle 100. The vehicle 100 may be an autonomous vehicle (AV), which may include any level of automation (e.g. levels 0-5), which includes no automation or full automation (level 5). The vehicle 100 may implement the safety system 200 as part of any suitable type of autonomous or driving assistance control system, including AV and/or advanced driver-assistance system (ADAS), for instance. The safety system 200 may include one or more components that are integrated as part of the vehicle 100 during manufacture, part of an add-on or aftermarket device, or combinations of these. Thus, the various components of the safety system 200 as shown in FIG. 2 may be integrated as part of the vehicle's systems and/or part of an aftermarket system that is installed in the vehicle 100.

The one or more processors 102 may be integrated with or separate from an electronic control unit (ECU) of the vehicle 100 or an engine control unit of the vehicle 100, which may be considered herein as a specialized type of an electronic control unit. The safety system 200 may generate data to control or assist to control the ECU and/or other components of the vehicle 100 to directly or indirectly control the driving of the vehicle 100. However, the aspects described herein are not limited to implementation within autonomous or semi-autonomous vehicles, as these are provided by way of example. The aspects described herein may be implemented as part of any suitable type of vehicle that may be capable of travelling with or without any suitable level of human assistance in a particular driving environment. Therefore, one or more of the various vehicle components such as those discussed herein with reference to FIG. 2 for instance, may be implemented as part of a standard vehicle (i.e. a vehicle not using autonomous driving functions), a fully autonomous vehicle, and/or a semi-autonomous vehicle, in various aspects. In aspects implemented as part of a standard vehicle, it is understood that the safety system 200 may perform alternate functions, and thus in accordance with such aspects the safety system 200 may alternatively represent any suitable type of system that may be implemented by a standard vehicle without necessarily utilizing autonomous or semi-autonomous control related functions.

Regardless of the particular implementation of the vehicle 100 and the accompanying safety system 200 as shown in FIG. 1 and FIG. 2, the safety system 200 may include one or more processors 102, one or more image acquisition devices 104 such as, e.g., one or more cameras or any other suitable sensor configured to perform image acquisition over any suitable range of wavelengths, one or more position sensors 106, which may be implemented as a position and/or location-identifying system such as a Global Navigation Satellite System (GNSS), e.g., a Global Positioning System (GPS), one or more memories 202, one or more map databases 204, one or more user interfaces 206 (such as, e.g., a display, a touch screen, a microphone, a loudspeaker, one or more buttons and/or switches, and the like), and one or more wireless transceivers 208, 210, 212.

The wireless transceivers 208, 210, 212 may be configured to operate in accordance with any suitable number and/or type of desired radio communication protocols or standards. By way of example, a wireless transceiver (e.g., a first wireless transceiver 208) may be configured in accordance with a Short Range mobile radio communication standard such as e.g. Bluetooth, Zigbee, and the like. As another example, a wireless transceiver (e.g., a second wireless transceiver 210) may be configured in accordance with a Medium or Wide Range mobile radio communication standard such as e.g. a 3G (e.g. Universal Mobile Telecommunications System—UMTS), a 4G (e.g. Long Term Evolution—LTE), or a 5G mobile radio communication standard in accordance with corresponding 3GPP (3 rd Generation Partnership Project) standards, the most recent version at the time of this writing being the 3GPP Release 16(2020 ).

As a further example, a wireless transceiver (e.g., a third wireless transceiver 212) may be configured in accordance with a Wireless Local Area Network communication protocol or standard such as e.g. in accordance with IEEE 802.11 Working Group Standards, the most recent version at the time of this writing being IEEE Std 802.11™-2020, published Feb. 26, 2021 (e.g. 802.11, 802.11a, 802.11b, 802.11g, 802.11n, 802.11p, 802.11-12, 802.11ac, 802.11ad, 802.11ah, 802.11ax, 802.11ay, and the like). The one or more wireless transceivers 208, 210, 212 may be configured to transmit signals via an antenna system (not shown) using an air interface. As additional examples, one or more of the transceivers 208, 210, 212 may be configured to implement one or more vehicle to everything (V2X) communication protocols, which may include vehicle to vehicle (V2V), vehicle to infrastructure (V2I), vehicle to network (V2N), vehicle to pedestrian (V2P), vehicle to device (V2D), vehicle to grid (V2G), and any other suitable communication protocols.

One or more of the wireless transceivers 208, 210, 212 may additionally or alternatively be configured to enable communications between the vehicle 100 and one or more other remote computing devices via one or more wireless links 140. This may include, for instance, communications with a remote server or other suitable computing system 150 as shown in FIG. 1. The example shown FIG. 1 illustrates such a remote computing system 150 as a cloud computing system, although this is by way of example and not limitation, and the computing system 150 may be implemented in accordance with any suitable architecture and/or network and may constitute one or several physical computers, servers, processors, etc. that comprise such a system. As another example, the computing system 150 may be implemented as an edge computing system and/or network.

The one or more processors 102 may implement any suitable type of processing circuitry, other suitable circuitry, memory, etc., and utilize any suitable type of architecture. The one or more processors 102 may be configured as a controller implemented by the vehicle 100 to perform various vehicle-based functions, which may include control functions, navigational functions, etc. For example, the one or more processors 102 may be configured to function as a controller for the vehicle 100 to analyze sensor data and received communications, to calculate specific actions for the vehicle 100 to execute for navigation and/or control of the vehicle 100, and to cause the corresponding action to be executed, which may be in accordance with an AV or ADAS system, for instance, and thus may alternatively be referred to herein as an AV/ADAS system. The one or more processors and/or the safety system 200 (e.g. any of the processors 214A, 214B, 216, and/or 218 of the one or more processors 102) may form the entirety of or portion of an advanced driver-assistance system (ADAS) or an autonomous vehicle (AV) system, which may leverage one or more machine vision based object or feature classification processes, which may include the use of any suitable computer vision (CV) algorithms as discussed in further detail herein.

Moreover, one or more of the processors 214A, 214B, 216, and/or 218 of the one or more processors 102 may be configured to work in cooperation with one another and/or with other components of the vehicle 100 to collect information about the environment (e.g., sensor data, such as images, depth information (for a lidar for example), etc.). In this context, one or more of the processors 214A, 214B, 216, and/or 218 of the one or more processors 102 may be referred to as “processors.” The processors may thus be implemented (independently or together) to create mapping information from the harvested data, e.g., Road Segment Data (RSD) information that may be used for Road Experience Management (REM) mapping technology, the details of which are further described below. As another example, the processors can be implemented to process mapping information (e.g. roadbook information used for REM mapping technology) received from remote servers over a wireless communication link (e.g. link 140) to localize the vehicle 100 on an AV map, which can be used by the processors to control the vehicle 100.

The one or more processors 102 may include one or more application processors 214A, 214B, an image processor 216, a communication processor 218, and may additionally or alternatively include any other suitable processing device, circuitry, components, etc. not shown in the Figures for purposes of brevity. Similarly, image acquisition devices 104 may include any suitable number of image acquisition devices and components depending on the requirements of a particular application. Image acquisition devices 104 may include one or more image capture devices (e.g., cameras, charge coupling devices (CCDs), or any other type of image sensor). The safety system 200 may also include a data interface communicatively connecting the one or more processors 102 to the one or more image acquisition devices 104. For example, a first data interface may include any wired and/or wireless first link 220, or first links 220 for transmitting image data acquired by the one or more image acquisition devices 104 to the one or more processors 102, e.g., to the image processor 216.

The wireless transceivers 208, 210, 212 may be coupled to the one or more processors 102, e.g., to the communication processor 218, e.g., via a second data interface. The second data interface may include any wired and/or wireless second link 222 or second links 222 for transmitting radio transmitted data acquired by wireless transceivers 208, 210, 212 to the one or more processors 102, e.g., to the communication processor 218. Such transmissions may also include communications (one-way or two-way) between the vehicle 100 and one or more other (target) vehicles in an environment of the vehicle 100 (e.g., to facilitate coordination of navigation of the vehicle 100 in view of or together with other (target) vehicles in the environment of the vehicle 100), or even a broadcast transmission to unspecified recipients in a vicinity of the transmitting vehicle 100.

The memories 202, as well as the one or more user interfaces 206, may be coupled to each of the one or more processors 102, e.g., via a third data interface. The third data interface may include any wired and/or wireless third link 224 or third links 224. Furthermore, the position sensors 106 may be coupled to each of the one or more processors 102, e.g., via the third data interface.

Each processor 214A, 214B, 216, 218 of the one or more processors 102 may be implemented as any suitable number and/or type of hardware-based processing devices (e.g. processing circuitry), and may collectively, i.e. with the one or more processors 102, form one or more types of controllers as discussed herein. The architecture shown in FIG. 2 is provided for ease of explanation and as an example, and the vehicle 100 may include any suitable number of the one or more processors 102, each of which may be similarly configured to utilize data received via the various interfaces and to perform one or more specific tasks.

For example, the one or more processors 102 may form a controller that is configured to perform various control-related functions of the vehicle 100 such as the calculation and execution of a specific vehicle following speed, velocity, acceleration, braking, steering, trajectory, etc. As another example, the vehicle 100 may, in addition to or as an alternative to the one or more processors 102, implement other processors (not shown) that may form a different type of controller that is configured to perform additional or alternative types of control-related functions. Each controller may be responsible for controlling specific subsystems and/or controls associated with the vehicle 100. In accordance with such aspects, each controller may receive data from respectively coupled components as shown in FIG. 2 via respective interfaces (e.g. 220, 222, 224, 232, etc.), with the wireless transceivers 208, 210, and/or 212 providing data to the respective controller via the second links 222, which function as communication interfaces between the respective wireless transceivers 208, 210, and/or 212 and each respective controller in this example.

To provide another example, the application processors 214A, 214B may individually represent respective controllers that work in conjunction with the one or more processors 102 to perform specific control-related tasks. For instance, the application processor 214A may be implemented as a first controller, whereas the application processor 214B may be implemented as a second and different type of controller that is configured to perform other types of tasks as discussed further herein. In accordance with such aspects, the one or more processors 102 may receive data from respectively coupled components as shown in FIG. 2 via the various interfaces 220, 222, 224, 232, etc., and the communication processor 218 may provide communication data received from other vehicles (or to be transmitted to other vehicles) to each controller via the respectively coupled links 240A, 240B, which function as communication interfaces between the respective application processors 214A, 214B and the communication processors 218 in this example.

The one or more processors 102 may additionally be implemented to communicate with any other suitable components of the vehicle 100 to determine a state of the vehicle while driving or at any other suitable time. For instance, the vehicle 100 may include one or more vehicle computers, sensors, ECUs, interfaces, etc., which may collectively be referred to as vehicle components 230 as shown in FIG. 2. The one or more processors 102 are configured to communicate with the vehicle components 230 via an additional data interface 232, which may represent any suitable type of links and operate in accordance with any suitable communication protocol (e.g. CAN bus communications). Using the data received via the data interface 232, the one or more processors 102 may determine any suitable type of vehicle status information such as the current drive gear, current engine speed, acceleration capabilities of the vehicle 100, etc. As another example, various metrics used to control the speed, acceleration, braking, steering, etc. may be received via the vehicle components 230, which may include receiving any suitable type of signals that are indicative of such metrics or varying degrees of how such metrics vary over time (e.g. brake force, wheel angle, reverse gear, etc.).

The one or more processors 102 may include any suitable number of other processors 214A, 214B, 216, 218, each of which may comprise processing circuitry such as sub-processors, a microprocessor, pre-processors (such as an image pre-processor), graphics processors, a central processing unit (CPU), support circuits, digital signal processors, integrated circuits, memory, or any other types of devices suitable for running applications and for data processing (e.g. image processing, audio processing, etc.) and analysis and/or to enable vehicle control to be functionally realized. In some aspects, each processor 214A, 214B, 216, 218 may include any suitable type of single or multi-core processor, microcontroller, central processing unit, etc. These processor types may each include multiple processing units with local memory and instruction sets. Such processors may include video inputs for receiving image data from multiple image sensors, and may also include video out capabilities.

Any of the processors 214A, 214B, 216, 218 disclosed herein may be configured to perform certain functions in accordance with program instructions, which may be stored in the local memory of each respective processor 214A, 214B, 216, 218, or accessed via another memory that is part of the safety system 200 or external to the safety system 200. This memory may include the one or more memories 202. Regardless of the particular type and location of memory, the one or more memories 202 may store software and/or executable (i.e. computer-readable) instructions that, when executed by a relevant processor (e.g., by the one or more processors 102, one or more of the processors 214A, 214B, 216, 218, etc.), controls the operation of the safety system 200 and may perform other functions such those identified with the aspects described in further detail below. This may include, for instance, identifying the location of the vehicle 100 (e.g. via the one or more position sensors 106), These functions may include the execution of any suitable machine vision based object or feature classification processes, which may include the use of any suitable computer vision (CV) algorithms as discussed in further detail herein., etc., the execution of vehicle-based functions, the implementation of an image sensor model, any functions associated with the AV/ADAS system of the vehicle 100, etc., as further discussed herein.

A relevant memory accessed by the one or more processors 214A, 214B, 216, 218 (e.g. the one or more memories 202) may also store one or more databases and image processing software, as well as a trained system, such as a neural network, or a deep neural network, for example, that may be utilized to perform the tasks in accordance with any of the aspects as discussed herein. A relevant memory accessed by the one or more processors 214A, 214B, 216, 218 (e.g. the one or more memories 202) may be implemented as any suitable number and/or type of non-transitory computer-readable medium such as random access memories, read only memories, flash memories, disk drives, optical storage, tape storage, removable storage, or any other suitable types of storage.

The components associated with the safety system 200 as shown in FIG. 2 are illustrated for ease of explanation and by way of example and not limitation. The safety system 200 may include additional, fewer, or alternate components as shown and discussed herein with reference to FIG. 2. Moreover, one or more components of the safety system 200 may be integrated or otherwise combined into common processing circuitry components or separated from those shown in FIG. 2 to form distinct and separate components. For instance, one or more of the components of the safety system 200 may be integrated with one another on a common die or chip. As an illustrative example, the one or more processors 102 and the relevant memory accessed by the one or more processors 214A, 214B, 216, 218 (e.g. the one or more memories 202) may be integrated on a common chip, die, package, etc., and together comprise a controller or system configured to perform one or more specific tasks or functions. Again, such a controller or system may be configured to execute the various functions related to performing vehicle-based functions based upon an analysis of the output of an image sensor model and/or an image sensor performance profile dataset, as discussed in further detail herein.

In some aspects, the safety system 200 may further include components such as a speed sensor 108 (e.g. a speedometer) for measuring a speed of the vehicle 100. The safety system 200 may also include one or more sensors 105, which may include one or more accelerometers (either single axis or multiaxis) for measuring accelerations of the vehicle 100 along one or more axes, and additionally or alternatively one or more gyro sensors. The one or more sensors 105 may further include additional sensors or different sensor types such as an ultrasonic sensor, infrared sensors, a thermal sensor, digital compasses, and the like. The safety system 200 may also include one or more radar sensors 110 and one or more lidar sensors 112 (which may be integrated in the head lamps of the vehicle 100). The radar sensors 110 and/or the lidar sensors 112 may be configured to provide pre-processed sensor data, such as radar target lists or lidar target lists. The third data interface (e.g., one or more links 224) may couple the one or more sensors 105, the speed sensor 108, the one or more radar sensors 110, and the one or more lidar sensors 112 to at least one of the one or more processors 102.

### II. Autonomous Vehicle (AV) Map Data and Road Experience Management (REM)

Data referred to as REM map data (or alternatively as Roadbook Map data or AV map data), may also be stored in a relevant memory accessed by the one or more processors 214A, 214B, 216, 218 (e.g. the one or more memories 202) or in any suitable location and/or format, such as in a local or cloud-based database, accessed via communications between the vehicle and one or more external components (e.g. via the transceivers 208, 210, 212), etc. It is noted that although referred to herein as “AV map data,” the data may be implemented in any suitable vehicle platform, which may include vehicles having any suitable level of automation (e.g. levels 0-5), as noted above.

Regardless of where the AV map data is stored and/or accessed, the AV map data may include a geographic location of known landmarks that are readily identifiable in the navigated environment in which the vehicle 100 travels. The location of the landmarks may be generated from a historical accumulation from other vehicles driving on the same road that collect data regarding the appearance and/or location of landmarks (e.g. “crowd sourcing”). Thus, each landmark may be correlated to a set of predetermined geographic coordinates that has already been established. Therefore, in addition to the use of location-based sensors such as GNSS, the database of landmarks provided by the AV map data enables the vehicle 100 to identify the landmarks using the one or more image acquisition devices 104. Once identified, the vehicle 100 may implement other sensors such as lidar, accelerometers, speedometers, etc. or images from the image acquisitions device 104, to evaluate the position and location of the vehicle 100 with respect to the identified landmark positions.

Furthermore, the vehicle 100 may determine its own motion, which is referred to as “ego-motion.” Ego-motion is generally used for computer vision algorithms and other similar algorithms to represent the motion of a vehicle camera across a plurality of frames, which provides a baseline (i.e. a spatial relationship) that can be used to compute the 3D structure of a scene from respective images. The vehicle 100 may analyze its own ego-motion to track the position and orientation of the vehicle 100 with respect to the identified known landmarks. Because the landmarks are identified with predetermined geographic coordinates, the vehicle 100 may determine its geographic location and position on a map based upon a determination of its position with respect to identified landmarks using the landmark-correlated geographic coordinates. Doing so provides distinct advantages that combine the benefits of smaller scale position tracking with the reliability of GNSS positioning systems while avoiding the disadvantages of both systems. It is further noted that the analysis of ego motion in this manner is one example of an algorithm that may be implemented with monocular imaging to determine a relationship between a vehicle's location and the known location of known landmark(s), thus assisting the vehicle to localize itself. However, ego-motion is not necessary or relevant for other types of technologies, and therefore is not essential for localizing using monocular imaging. Thus, in accordance with the aspects as described herein, the vehicle 100 may leverage any suitable type of localization technology.

The AV map data is generally constructed as part of a series of steps, which may involve any suitable number of vehicles that opt into the data collection process. As each vehicle collects data, the data is classified into tagged data points, which are then transmitted to the cloud or to another suitable external location. A suitable computing device (e.g. a cloud server such as the computing system 150) then analyzes the data points from individual drives on the same road, and aggregates and aligns these data points with one another. After alignment has been performed, the data points are used to define a precise outline of the road infrastructure. Next, relevant semantics are identified that enable vehicles to understand the immediate driving environment, i.e. features and objects are defined that are linked to the classified data points. The features and objects defined in this manner may include, for instance, traffic lights, road arrows, signs, road edges, drivable paths, lane split points, stop lines, lane markings, etc. to the driving environment so that a vehicle may readily identify these features and objects using the AV map data. This information is then compiled into a Roadbook Map, which constitutes a bank of driving paths, semantic road information such as features and objects, and aggregated driving behavior.

A map database 204, which may be stored as part of the one or more memories 202 or accessed via the computing system 150 via the link(s) 140, for instance, may include any suitable type of database configured to store (digital) map data for the vehicle 100, e.g., for the safety system 200. The one or more processors 102 may download information to the map database 204 over a wired or wireless data connection (e.g. the link(s) 140) using a suitable communication network (e.g., over a cellular network and/or the Internet, etc.). Again, the map database 204 may store the AV map data, which includes data relating to the position, in a reference coordinate system, of various landmarks such as items, including roads, water features, geographic features, businesses, points of interest, restaurants, gas stations, etc.

The map database 204 may thus store, as part of the AV map data, not only the locations of such landmarks, but also descriptors relating to those landmarks, including, for example, names associated with any of the stored features, and may also store information relating to details of the items such as a precise position and orientation of items. In some cases, the Roadbook Map data may store a sparse data model including polynomial representations of certain road features (e.g., lane markings) or target trajectories for the vehicle 100. The AV map data may also include stored representations of various recognized landmarks that may be provided to determine or update a known position of the vehicle 100 with respect to a target trajectory. The landmark representations may include data fields such as landmark type, landmark location, etc., among other potential identifiers. The AV map data may also include non-semantic features including point clouds of certain objects or features in the environment, and feature point and descriptors.

The map database 204 may be augmented with data in addition to the AV map data, and/or the map database 204 and/or the AV map data may reside partially or entirely as part of the remote computing system 150. As discussed herein, the location of known landmarks and map database information, which may be stored in the map database 204 and/or the remote computing system 150, may form what is referred to herein as a “AV map data, “REM map data,” or “Roadbook Map data.” Thus, the one or more processors 102 may process sensory information (such as images, radar signals, depth information from lidar or stereo processing of two or more images) of the environment of the vehicle 100 together with position information, such as GPS coordinates, the vehicle's ego-motion, etc., to determine a current location, position, and/or orientation of the vehicle 100 relative to the known landmarks by using information contained in the AV map. The determination of the vehicle's location may thus be refined in this manner. Certain aspects of this technology may additionally or alternatively be included in a localization technology such as a mapping and routing model.

### III. Safety Driving Model

Furthermore, the safety system 200 may implement a safety driving model or SDM, which may be utilized and/or executed as part of the ADAS system as discussed herein. By way of example, the safety system 200 may include (e.g. as part of a driving policy) a computer implementation of a formal model such as a safety driving model. A safety driving model may include an implementation of a mathematical model formalizing an interpretation of applicable laws, standards, policies, etc. that are applicable to self-driving (e.g., ground) vehicles. In some embodiments, the SDM may comprise a standardized driving policy such as the Responsibility Sensitivity Safety (RSS) model. However, the embodiments are not limited to this particular example, and the SDM may be implemented using any suitable driving policy model that defines various safety parameters that the AV should comply with to facilitate safe driving.

For instance, the SDM may be designed to achieve, e.g., three goals: first, the interpretation of the law should be sound in the sense that it complies with how humans interpret the law; second, the interpretation should lead to a useful driving policy, meaning it will lead to an agile driving policy rather than an overly-defensive driving which inevitably would confuse other human drivers and will block traffic, and in turn limit the scalability of system deployment; and third, the interpretation should be efficiently verifiable in the sense that it can be rigorously proven that the self-driving (autonomous) vehicle correctly implements the interpretation of the law. An implementation in a host vehicle of a safety driving model (e.g. the vehicle 100) may be or include an implementation of a mathematical model for safety assurance that enables identification and performance of proper responses to dangerous situations such that self-perpetrated accidents can be avoided.

A safety driving model may implement logic to apply driving behavior rules such as the following five rules:
Do not hit someone from behind.
Do not cut-in recklessly.
Right-of-way is given, not taken.
Be careful of areas with limited visibility.
If you can avoid an accident without causing another one, you must do it.

It is to be noted that these rules are not limiting and not exclusive, and can be amended in various aspects as desired. The rules thus represent a social driving “contract” that might be different depending upon the region, and may also develop over time. While these five rules are currently applicable in most countries, the rules may not be complete or the same in each region or country and may be amended.

As described above, the vehicle 100 may include the safety system 200 as also described with reference to FIG. 2. Thus, the safety system 200 may generate data to control or assist to control the ECU of the vehicle 100 and/or other components of the vehicle 100 to directly or indirectly navigate and/or control the driving operation of the vehicle 100, such navigation including driving the vehicle 100 or other suitable operations as further discussed herein. This navigation may optionally include adjusting one or more SDM parameters, which may occur in response to the detection of any suitable type of feedback that is obtained via image processing, sensor measurements, etc. The feedback used for this purpose may be collectively referred to herein as “environmental data measurements” and include any suitable type of data that identifies a state associated with the external environment, the vehicle occupants, the vehicle 100, and/or the cabin environment of the vehicle 100, etc.

For instance, the environmental data measurements may be used to identify a longitudinal and/or lateral distance between the vehicle 100 and other vehicles, the presence of objects in the road, the location of hazards, etc. The environmental data measurements may be obtained and/or be the result of an analysis of data acquired via any suitable components of the vehicle 100, such as the one or more image acquisition devices 104, the one or more position sensors 105, the position sensors 106, the speed sensor 108, the one or more radar sensors 110, the one or more lidar sensors 112, etc. To provide an illustrative example, the environmental data may be used to generate an environmental model based upon any suitable combination of the environmental data measurements. Thus, the vehicle 100 may utilize the tasks performed via trained model(s) to perform various navigation-related operations within the framework of the driving policy model.

The navigation-related operation may be performed, for instance, by generating the environmental model and using the driving policy model in conjunction with the environmental model to determine an action to be carried out by the vehicle. That is, the driving policy model may be applied based upon the environmental model to determine one or more actions (e.g. navigation-related operations) to be carried out by the vehicle. The SDM may represent the driving policy model or, alternatively, may be used in conjunction (as part of or as an added layer) with the driving policy model to assure a safety of an action to be carried out by the vehicle at any given instant. For example, the ADAS may leverage or reference the SDM parameters defined by the safety driving model to determine navigation-related operations of the vehicle 100 in accordance with the environmental data measurements depending upon the particular scenario. The navigation-related operations may thus cause the vehicle 100 to execute a specific action based upon the environmental model to comply with the SDM parameters defined by the SDM model as discussed herein. In other words, the environmental model may be generated at least in part on sensor data received via the various sensors of the vehicle 100 as noted herein, and the applicable driving policy model may then be applied together with the environmental model to determine a navigation-related operation to be performed by the vehicle. Examples of SDM parameters may include a maximum speed, a minimum (e.g. longitudinal) following distance from the vehicle 100 to another vehicle, a minimum lateral distance between the vehicle 100 and other vehicles, etc.

Iv. Image Sensor Profiling

Again, conventional image sensor testing has various drawbacks and fails to provide a robust and complete evaluation of an image sensor. The embodiments as discussed herein address these issues by providing an image sensor profiling process and accompanying architecture that facilitates performing a full range profile process over a range of different operating parameters of the image sensor. This may include, for instance, performing an image quality measurement for one exposure over a range of light levels, and then repeating these measurements for a set of exposure settings of the image sensor. The image quality measurements may be optionally performed considering other parameters such as color ratios, contrast targets, confidence intervals, sensor temperature, etc. Such parameters may be adjusted in accordance with any suitable granularity thereof to ensure that the image sensor is profiled across a wide range of expected operating conditions.

Thus, the embodiments include generating, from these measurements, an image sensor performance profile dataset. This dataset may provide contrast detection probability (CDP) measurement data, as well as other optional data such as color ratio data, over a full range of operating parameters of an image sensor. The CDP measurement data may also be referred to as Contrast Transfer Accuracy, which is a known metric. Thus, although the disclosure uses the term “contrast detection probability” herein, this is to be understood as the equivalent of contrast Transfer Accuracy or other suitable terms describing this same metric. The CDP measurement data may include CDP values, which may represent the probability of being able to measure an expected contrast level between two areas of an image (e.g. one brighter, one darker) within a specified confidence interval. This probability may be reduced for any suitable number of reasons, which may include a non-linearity in the detector, noise at the detector, etc. As further discussed below, the image sensor performance profile dataset may thus quantify the image quality for a full range of sensor operation across of different exposure values and different light levels. The generation of this image sensor performance profile dataset may be attained by way of the embodiments discussed herein in a matter of a few hours versus the conventional process of several days or weeks, may be fully automated, and may be measured with respect to a comprehensive set of parameters that the image sensor may be expected to operate during its subsequent deployment in a vehicle.

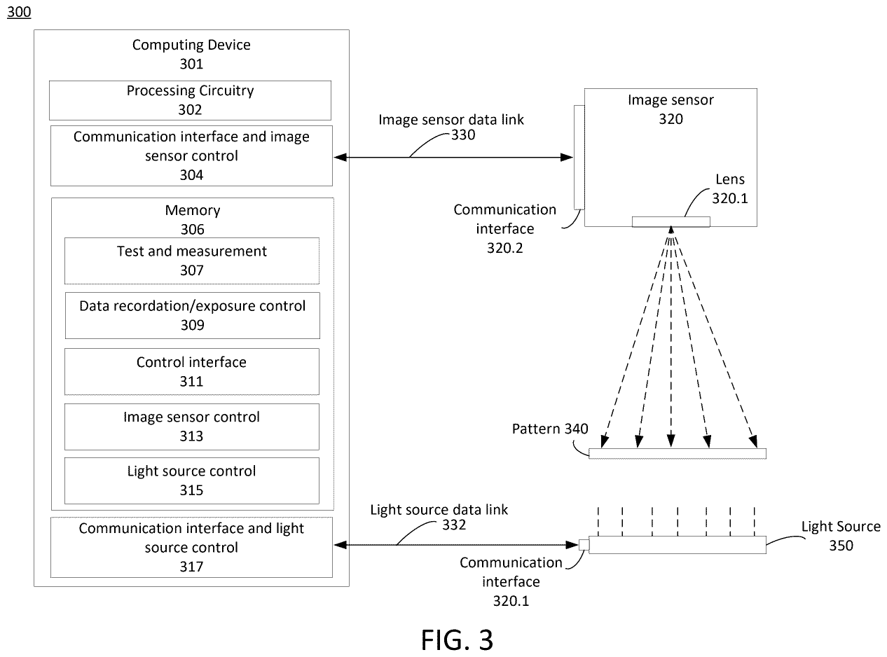

FIG. 3 illustrates an example architecture for generating a full range image sensor performance profile dataset, in accordance with one or more aspects of the present disclosure. As shown in FIG. 3, the system 300 may comprise a computing device 301, an image sensor 320 that is to be profiled (e.g. a “sensor under test”), a pattern 340, and a light source 350. As further discussed herein, the computing device 301 is configured to configure and/or control the image sensor 320 by adjusting the various operating parameters used to acquire images of the pattern 340, such as exposure values for instance, and to receive frames of the images acquired by the image sensor 320. Additionally, the computing device 301 is configured to configure and/or control the light source 350 to adjust the light levels emitted by the light source onto the pattern 340. Thus, and as discussed in further detail below, the computing device 301 is configured to capture image frames acquired by the image sensor 320 over a range of different exposure values of the image sensor 320 and light levels of the pattern 340 to generate the image sensor performance profile dataset. Of course, these are only example parameters, and the image sensor performance profile dataset may be generated by varying additional or alternate parameters, with additional examples of such alternate parameters being discussed further below. The configuration shown in FIG. 3 is provided by way of example and not limitation, and other configurations are envisioned. For instance, an alternative configuration may replace the pattern 340 with a set of neutral-density (ND) filters of various densities to represent the patches of different ND in the pattern or to adjust the light level of the light source 350 at any suitable levels. This configuration would provide similar differences in light levels to mimic the different patches in the pattern as the use of the pattern 340. For instance, the image sensor 320 may capture an image for each ND filter and/or light level, as opposed to one image for the patches in the pattern.

As shown in FIG. 3, the image sensor 320 may be mounted or otherwise affixed to any suitable type of mounting configuration (not shown) and aligned with (e.g. aimed towards) a pattern 340. The pattern 340 may be disposed a predetermined distance from the image sensor 320 and may comprise any suitable type of test image used for profiling the image sensor 320. For example, the pattern 340 may be transparent, translucent, semi-transparent, semi-translucent, etc., comprise a chart of patches having a predetermined size and contrast difference with respect to one another. The pattern 340 may represent a standardized chart that may be used for the computation of contrast detection probability (CDP) measurements. For instance, the pattern 340 may comprise a TE295 chart, which supports measurements of small contrasts and has a 0.3 OD delta between patches. The implementation of the pattern 340 is discussed in further detail below.

The light source 350 may be implemented as any suitable type of light source, which may be for instance arranged behind the pattern 340 with respect to the image sensor 320. That is, the pattern 340 may be disposed between the image sensor 320 and the light source 350. The light source 350 may thus enable the image sensor 320 to acquire image frames of the pattern 340 at different light levels as the light source 350 is controlled via the computing device 301. The light source 350 may be implemented as a specialized light source for this purpose. For instance, the light source 350 may be implemented as any suitable type of flat constant (e.g. non-flickering) light source containing a diffusor such that the emitted light is evenly distributed across the surface with no measurable contrast between areas of the light source. An example of such a light source may include a Vega light source, which is used to perform high precision measurements of exceedingly short exposure times often seen in automotive-grade cameras. In accordance with such embodiments, the light source 350 may implement LEDs that are driven by DC (direct current) technology to prevent flickering, and may provide a light range between 0.1 and to 50,000 cd/m2 for example.

To perform (e.g. calculate, retrieve, or otherwise obtain) the measurements to generate the image sensor performance profile dataset as discussed in further detail herein, the computing device 301 may be identified with any suitable type of device configured to control the image sensor 320 and the light source 350, as well as to acquire, store, and analyze image frames of the pattern 340 captured via the image sensor 320 as discussed in further detail herein. Thus, the computing device 301 may be configured to perform any of the operations as discussed herein to generate the image sensor performance profile dataset, and may be performed as part of a semi- or fully-automated process. For instance, the computing device 301 may comprise a laptop computer, a desktop computer or workstation, a mobile phone, a server or cloud-based computing device, a tablet, etc. The computing device 301 may thus be configured to perform the various operations as discussed herein to generate the image sensor performance profile dataset of the image sensor 320 via one or more components transmitting and/or receiving control signals and/or data to and/or from the image sensor 320 and/or the light source 350, such as via the image sensor data link 330 and the light source data link 332, for instance.

As shown in FIG. 3, the computing device 301 may include processing circuitry 302, a communication interface and image sensor control circuitry 304, a communication interface and light source control circuitry 317, and a memory 306. The components shown in FIG. 3 are provided for ease of explanation, and the computing device 301 may implement additional, fewer, or alternative components as those shown in FIG. 3.

The communication interface and image sensor control circuitry 304 and the communication interface and light source control circuitry 317 may be implemented as any suitable number and/or type of components configured to transmit and/or receive data (such as data packets, control signals, etc.) and/or wireless signals in accordance with any suitable number and/or type of communication protocols. The communication interface and image sensor control circuitry 304 and the communication interface and light source control circuitry 317 may include any suitable type of components to facilitate this functionality, including components associated with known transceiver, transmitter, and/or receiver operation, configurations, and implementations. The communication interface and image sensor control circuitry 304 and the communication interface and light source control circuitry 317 may include components typically identified with communication interfaces and include e.g. drivers, connectors, terminals, wires, antennas, ports, amplifiers, buffers, buses, etc. Thus, the communication interface and image sensor control circuitry 304 and the communication interface and light source control circuitry 317 may be configured as any suitable number and/or type of components configured to facilitate receiving and/or transmitting signals and/or data in accordance with any suitable number and/or type of communication protocols, which may be standardized or non-standardized protocols.

For instance, the communication interface and image sensor control circuitry 304 may be implemented as any suitable number and/or type of hardware and/or software components configured to enable communication between the computing device 301 and the particular image sensor 320 for which a corresponding image sensor performance profile dataset is to be generated. For example, the communication interface and image sensor control circuitry 304 may enable the computing device 301 to receive image frames acquired by the image sensor 320, e.g. those of the pattern 340 as discussed herein. Additionally or alternatively, the communication interface and image sensor control circuitry 304 may enable the computing device 301 to control the various settings and/or parameters of the image sensor 320, such as exposure settings for instance, and/or to trigger the acquisition of the image frames via the image sensor 320.

In any event, any communication and/or control in this manner between the computing device 301 and the image sensor 320 may be facilitated via data and/or control signals communicated via the image sensor data link 330, which may comprise any suitable number and/or type of buses, wires, interconnections, etc. Thus, the communication interface and image sensor control circuitry 304 may include any suitable type of data interface that is configured to transfer data to and/or from the image sensor 320 via a corresponding communication interface 320.2 of the image sensor 320 as shown. For example, the communication interface and image sensor control circuitry 304 may comprise a serializer, and the corresponding communication interface 320.2 of the image sensor 320 may comprise a de-serializer, or vice-versa. Additionally or alternatively, the image sensor control circuitry 304 may be implemented as a frame grabber, which enables control and acquisition of the images acquired via the image sensor 320 as discussed herein.

The communication interface and light source control circuitry 317 may be implemented as any suitable number and/or type of hardware and/or software components configured to enable communication between the computing device 301 and the light source 350. For example, the communication interface and light source control circuitry 317 may enable the computing device 301 to adjust a light level setting of the light source 350 to illuminate the pattern 340 at a variety of different illumination levels in accordance with any suitable granularity. Any such communication and/or control may be facilitated via data and/or control signals communicated via the light source data link 332, which may comprise any suitable number and/or type of buses, wires, interconnections, etc. Thus, the communication interface and light source control circuitry 317 may include any suitable type of data interface that is configured to transfer data to and/or from the light source 350 via a corresponding communication interface 320.1 of the light source 350 as shown. For example, the communication interface and light source control circuitry 317 may comprise a controller configured to control the light source 350. For embodiments in which the light source 350 comprises a Vega light source, the communication interface and light source control circuitry 317 may comprise a Vega light source controller.

The processing circuitry 302 may be configured as any suitable number and/or type of processors, which may function to control the computing device 301 and/or other components of the computing device 301. The processing circuitry 302 may be identified with one or more processors (or suitable portions thereof) implemented by the computing device 301 or a host system. The processing circuitry 302 may be identified with one or more processors such as a host processor, a digital signal processor, one or more microprocessors, microcontrollers, an application-specific integrated circuit (ASIC), part (or the entirety of) a field-programmable gate array (FPGA), etc.

In any event, the processing circuitry 302 may be configured to carry out instructions to perform arithmetical, logical, and/or input/output (I/O) operations, and/or to control the operation of one or more components of computing device 301 to perform various functions as described herein. The processing circuitry 302 may include one or more microprocessor cores, memory registers, buffers, clocks, etc., and may generate electronic control signals associated with the components of the computing device 301 to control and/or modify the operation of these components. The processing circuitry 302 may communicate with and/or control functions associated with any of the components of the computing device 301.

The memory 306 may store data and/or instructions such that, when the instructions are executed by the processing circuitry 302, cause the computing device 301 to perform the various functions as described herein with respect to the generation of the image sensor performance profile dataset, such as controlling, communicating, monitoring, regulating, etc., one or more of the components of the system 300 as further described herein. The memory 306 may be implemented as any suitable volatile and/or non-volatile memory, including read-only memory (ROM), random access memory (RAM), flash memory, a magnetic storage media, an optical disc, erasable programmable read only memory (EPROM), programmable read only memory (PROM), etc. The memory 306 may be non-removable, removable, or a combination of both. The memory 306 may be implemented as a non-transitory computer readable medium storing one or more executable instructions such as, for example, logic, algorithms, code, etc.

As further discussed herein, the instructions, logic, code, etc., stored in the memory 306 are represented by the various module(s) as shown, which may enable the functionality disclosed herein with respect to any or all portions of the system 300 to be functionally realized. Alternatively, the module(s) as shown in FIG. 3 that are associated with the memory 306 may include instructions and/or code to facilitate control and/or monitor the operation of hardware components implemented via the computing device 301. In other words, the module(s) shown in FIG. 3 are provided for ease of explanation regarding the functional association between hardware and software components.

Thus, the processing circuitry 302 may execute the instructions stored in these respective modules in conjunction with one or more hardware components to perform the various functions as discussed herein. Although the modules are illustrated separately and further described herein in this manner, this is for ease of explanation and is not intended to be limiting. The instructions in the modules of the memory 306 may be stored in any suitable manner, and may comprise instructions identified with execution of a single program, application, one or more algorithms that support such programs and/or applications, etc.

The communication interface and image sensor control circuitry 304 and the communication interface and light source control circuitry 317 may enable the computing device 301 to communicate with and/or control the image sensor 320 and the light source 350, respectively, via corresponding application programming interfaces (APIs). Thus, the image sensor control module 313 may store computer-readable instructions that, when executed via the processing circuitry 302, enable the computing device 301 to communicate with and/or control the image sensor 320 as discussed herein via a corresponding API. Additionally, the light source control module 315 may store computer-readable instructions that, when executed via the processing circuitry 302, enable the computing device 301 to communicate with and/or control the light source 250 as discussed herein via a corresponding API.

The control interface 311 may store computer-readable instructions that, when executed via the processing circuitry 302, enable the computing device 301 to execute the APIs as noted herein and to store the control parameters of the image sensor 320. For example, the control interface 311 may be implemented as any suitable type of software interface, such as a Python interface for instance. Additionally, the control interface 311 may store image sensor and exposure control parameters for a specific image sensor 320, which may be used in accordance with the APIs to perform the various measurements as discussed herein. For example, the control interface 311 may store image sensor parameters in a JavaScript Object Notation (JSON) format, initialization sequence parameters that define the measurements to be performed in a text format, and an exposure table for the image sensor 320 in a table (e.g. CSV) format.

The data recordation and exposure control module 309 may store computer-readable instructions that, when executed via the processing circuitry 302, enable the computing device 301 to control the exposure values of the image sensor 320 and to store the received image frames acquired via the image sensor 320 across a set of different exposure and light level settings, as discussed in further detail herein. The image frames may be stored in any suitable memory, including the memory 306 or other suitable memory accessible by the computing device 301.

The test and measurement module 307 may store computer-readable instructions that, when executed via the processing circuitry 302, enable the computing device 301 to perform the corresponding analysis used to generate the image sensor performance profile dataset as discussed herein. Thus, the test and measurement module 307 may facilitate the analysis of the stored image frames across a set of different exposure settings and light levels, as well as additional or alternative operating parameters, as discussed herein. This may include, for instance, calculating a contrast detection probability (CDP) measurement across a range of predetermined contrast targets, across a range of predetermined confidence intervals, across a range of different exposure settings, across a range of different light levels, etc., as discussed herein. The test and measurement module 307 may store computer-readable instructions that, when executed via the processing circuitry 302, enable the presentation of a suitable user interface via a display of the computing device 301 (not shown) to enable a user to set and/or modify any parameters of the test used to generate the image sensor performance profile dataset as discussed herein.

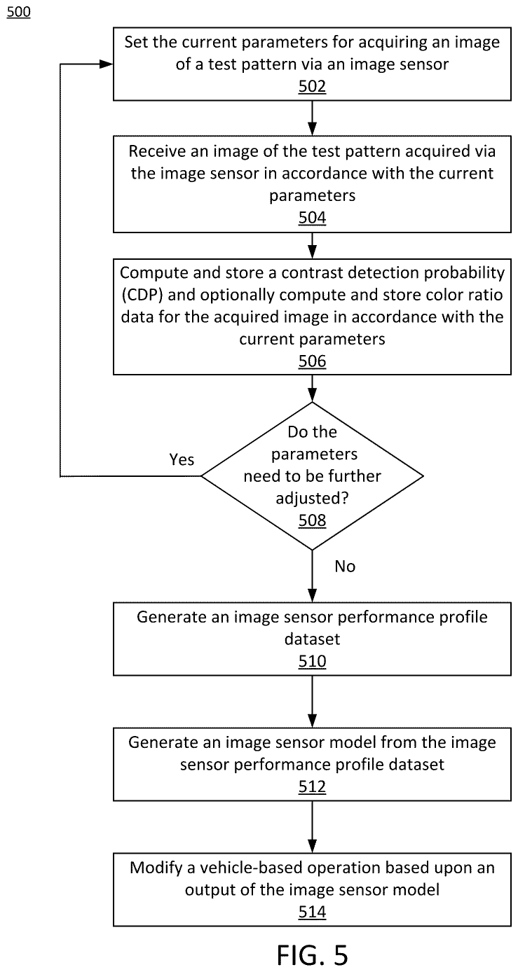

FIG. 5 illustrates an example process flow, in accordance with one or more aspects of the present disclosure. The functionality associated with the process flow 500 as discussed herein with reference to FIG. 5 may be executed, for instance, via a suitable computing device and/or processing circuitry identified with the system 300 and/or an AV/ADAS system of the vehicle 100. For example, the process flow 500 may be implemented via the processing circuitry 302 executing instructions stored on the memory 306 (which may be locally-stored instructions and/or as part of the processing circuitry). The process flow 500 may include alternate or additional steps that are not shown in FIG. 5 for purposes of brevity, and may be performed in a different order than the steps shown in FIG. 5.

The process flow 500 may begin when one or more processors set (block 502) the current parameters for acquiring an image of the pattern 340 via the image sensor 320. The parameters may include any suitable variables that may be adjusted in accordance with any suitable granularity to generate the image sensor performance profile dataset as discussed herein. For example, block 502 may comprise the computing device 301 setting, as the current parameters in this example, an initial exposure value for the image sensor 320 as well as an initial illumination setting for the light source 350, as noted above. The parameters may also comprise, for example, a predetermined contrast target and a predetermined confidence interval, as discussed in further detail below.

It is noted that the exposure value for the image sensor 320, the initial illumination setting, the predetermined contrast target, and the predetermined confidence interval are provided herein by way of example and not limitation, and the parameters that may be adjusted as discussed in further detail herein to generate the image sensor performance profile dataset may include any suitable parameters that may influence the CDP of images acquired via the image sensor 320. As another example, these parameters may include a temperature of the image sensor 320. To adjust the temperature, the computing device 301 may additionally perform (block 502) environmental control of a region in which the image sensor 320 is disposed when acquiring images of the pattern 340 as discussed herein. Such control may be implemented in any suitable manner, e.g. as a separate environmental control API and accompanying communication interface and links (not shown).

For example, the embodiments as discussed herein allow for the generated image sensor performance profile dataset to be used to compute or otherwise evaluate image sensor performance in accordance with several different confidence intervals, which may be adjusted based upon the anticipated application of the image sensor. For instance, the images generated by the image sensor 320 may be implemented as part of the safety system 200 of the vehicle 100 as noted above, and these images may be used to perform various CV processes, the outcome of which being used to perform various vehicle-based functions for the vehicle 100. Additional examples of vehicle-based functions and how the image sensor performance profile dataset may be used to affect these vehicle-based functions are provided in further detail below.

It is noted that the contrast target level (CTL) and the confidence interval (CI) may be defined in accordance with a particular application and/or context in which the images acquired via the image sensor 320 may be used. As one illustrative example, in some scenarios the image sensor 320 may be used to capture low contrast road surface images, and thus a smaller CTL with a smaller CI range (e.g. a CTL of 0.1 with a CI of 0.1) may be required. It is noted that a CI of 0.1 in this example refers to +/−10%. Furthermore, a CTL of 0.1 refers to a Michelson contrast calculated as “(S1−S0)/(S1+S0),” where S1 is the brighter surface and S0 is the darker surface. As another illustrative example, when images acquired by the image sensor 320 are used to detect a dark object on the road, the resulting images may be very noisy, thus requiring a larger CTL and a larger CI. In this way, in addition to the exposure values and illuminations settings, the parameters that are adjusted to generate the image sensor performance profile dataset may include different CIs that may be defined to generate the image sensor performance profile dataset, which may act to provide insight regarding the performance of the image sensor 320 for different use cases correlating to these different CI values, as discussed in further detail below.

Regardless of the particular parameters that are adjusted to generate the image sensor performance profile dataset, the process flow 500 may include receiving (block 504) an image of the pattern 340 that is acquired via the image sensor 320. This may include, for instance, the computing device 301 receiving the image of the pattern 340 acquired by the image sensor 320, which may be received for instance via the image sensor data link 330, as noted above. The computing device 301 may optionally store the acquired image in the memory 306 or another suitable memory accessible by the computing device 301.

The process flow 500 may include computing (block 506) a contrast detection probability (CDP) for the acquired image that has been acquired using the currently-established parameters (e.g. exposure setting, illumination setting, CI, contrast target, etc.). CDP is a key performance indicator (KPI) that measures an image sensor's ability to identify an object's contrast in its field of view. For example, the safety system 200 as noted herein may include an AV or ADAS, which should be configured to identify different objects within the vehicle's field of view, such as for instance identifying a difference between a road and an edge of the road.

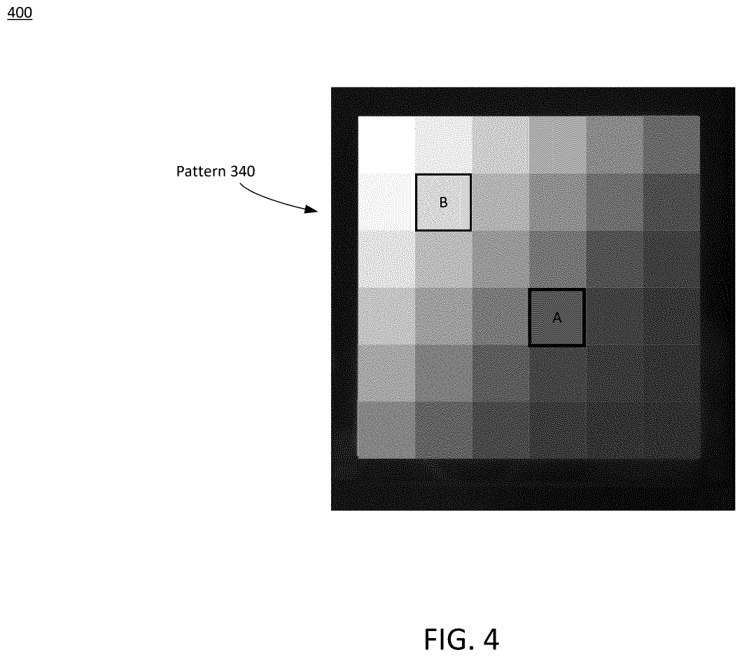

To measure the CDP from the acquired image, reference is now made to FIG. 4, which may comprise an example of the pattern 340. Thus, and as shown in FIG. 4, the image acquired in block 504 may be of the pattern 340 for a specific exposure value of the image sensor 320 and a specific illumination setting provided by the light source 350. The CDP may be computed (block 506) for the acquired image in any suitable manner, and this process may be repeated as the parameters are adjusted to acquire further images, as well as being repeated for the same acquired image when applicable.

For instance, the parameters may be adjusted without necessarily acquiring a new image of the pattern 340, such as when the parameters impact the CDP computation (e.g. adjustments to the contrast target and/or confidence interval) but not the manner in which the image is acquired (e.g. the exposure value and illumination). Thus, block 504 may be identified with receiving a new image to perform the CDP computations for that image or, alternatively, with accessing the stored image from a suitable memory to re-compute the CDP for that image in accordance with a different set of parameters (e.g. a different contrast target and/or CI). In this way, the generated image sensor performance profile dataset may comprise a set of CDP measurements over a range of the various parameters that are adjusted in block 502, e.g. the different exposure values, light levels, contrast targets, confidence intervals, etc., as discussed in further detail herein. Furthermore, these different measurements may provide key performance indicators (KPIs) covering a range of different types of objects or algorithm requirements such as the detection of road surfaces requiring a low texture compared to other scenarios.

As one example, the CDP may be computed by first performing (block 506) a calibration process in accordance with a specific contrast target that is defined in accordance with the established parameters (block 502). This contrast target may comprise, for example, an expected Michelson contrast with respect to various regions in the pattern 340. To provide some illustrative examples, this predetermined contrast target may comprise 10%, 20%, 30%, 50%, etc. Continuing this example, the pattern 340 as shown in FIG. 4 may include a number of pairs of patches having a predetermined contrast difference with respect to one another. For instance, a TE95 chart as shown in FIG. 4 typically includes patches having a predetermined contrast difference of 0.3% with respect to one another while moving in a diagonal manner down and across the pattern. The outcome is that the patch pairs are identified to measure each contrast target level (CTL) that is desired for the measurements such that these patch pairs are referenced for each set of images received.

Thus, block 506 may include, as this calibration process, first selecting a subset of patches that were identified to be used to identified the contrast target as described in the previous paragraph, and then finding the rectangular coordinates that would crop a small area of the patches to a predetermined number of pixels within each crop. This may include, for instance, cropping a predetermined portion (e.g. a predetermined number of pixels) within this subset of patches in the pattern 340. For instance, each one of the subset of patches may be cropped to an N×M set of pixels (e.g. 20×20, 30×30, etc.) centered within each of the subset of patches. Then, block 506 may include the computing device 301 selecting a subset of pixel pair combinations within the image of the pattern 340 (e.g. from among the subset of patches) having a brightness level (e.g. contrast level) difference with respect to one another that is within a predetermined threshold deviation of the predetermined contrast target.

Then, block 506 comprises calculating a set of Michelson contrast values between each possible combination of pixels sampled from the brighter and darker patch to create a statistical pairwise comparison to compare against the expected Contrast Target Level measured by the Michelson contrast calculation. Then, from the total set of Michelson contrast calculations from the pairwise comparison of pixel values between the two patches in this manner, block 506 comprises measuring a percentage of density combinations of the calculated versus expected contrast values within the current confidence interval, which again may be established as part of the initial parameters (block 502). The percentage of the calculated pairwise values matching the contrast target level within the specified confidence interval will provide the probability of the contrast being detected between these two patches. This process may then be repeated for every combination of two patches within the test pattern that meet the current predetermined contrast target, which results in the computation of the CDP for the image sensor 320 in accordance with the current parameters, e.g. the current contrast target, confidence interval, exposure setting, and light level.

However, to ensure a complete image sensor performance profile dataset is generated, the process flow 500 comprises determining (block 508) whether to adjust any of the parameter and, if so, then the CDP measurements are repeated. For instance, it may be desirable to generate the image sensor performance profile dataset with respect to a number of different predetermined contrast targets, and thus block 508 may comprise determining whether additional contrast targets are to be considered, which may be defined as part of the initial test process by a user or part of a predetermined set of parameters. In this case, the process described above may be repeated for a different predetermined contrast target. For instance, the calibration process may be repeated for an updated predetermined contrast target value to identify a new subset of patches in the stored image, which are then cropped and their respective pixels compared to measure a percentage of density combinations and a resulting CDP for the image sensor 320.

Next, block 508 may include determining whether additional measurements are to be performed for additional confidence intervals (CIs), and the measurements discussed above be repeated until the CDP of the image sensor is computed for each predetermined contrast target to be measured. As an illustrative example, and as discussed in the examples further herein, the different predetermined CTLs of 0.1, 0.2, and 0.5, and the CIs for each may comprise 0.1, 0.2, and 0.5. Thus, the CDP of the image sensor 320 may be computed for any suitable combination of both predetermined contrast target values and predetermined CIs.

Further, as the process flow 500 continues in this manner, the iterative determinations performed at block 508 may result in the adjustment (block 502) of the exposure values of the image sensor 320 and the illumination levels provided by the light source 350 to the pattern 340. As an illustrative example, the process flow 500 may be performed in accordance with two or three different exposure values and 10-20 different illumination levels. Thus, as each one of these parameters is adjusted, the computing device 301 may receive a different image acquired by the image sensor, and the same processes as described above may be repeated in each case for each newly-acquired image. For instance, the CDP of the images acquired via each combination of different pre-determined contrast targets and CIs may be computed for each newly-acquired image having a different exposure value and illumination level of the pattern 340. Thus, the process flow 500 may be repeated in this manner by adjusting the parameters and acquiring additional images in accordance with the updated parameters.

This process may continue until the decision at block 506 is “no,” resulting in the CDP of the image sensor 320 being computed over a set of images of the pattern 340 for every combination of parameters that are adjusted in block 502, e.g. each combination of the various predetermined contrast target values, confidence intervals, exposure values, and illumination levels. As a result, the CDP measurement is repeated for each one of the acquired images for different light levels of the predetermined pattern and different exposure values of the image sensor 320 to generate (block 510) an image sensor performance profile dataset that provides CDP measurements that are computed for each combination of the adjusted parameters. Any suitable number of such parameters may be adjusted in this manner to generate (block 508) the image sensor performance profile dataset. In this way, the image sensor performance profile dataset may represent the CDP of the image sensor 320 for a variety of light levels, which may represent most light data points across the image sensor's dynamic range, in combination with each of the other parameters that are adjusted, as discussed herein.

Once the image sensor performance profile dataset is computed in this manner, the process flow 500 comprises generating (block 512), using the image sensor performance profile dataset, an image sensor model. The image sensor model may be generated in any suitable manner that leverages the complete set of CDP measurements across all combinations of the parameters for which the process flow 500 is implemented to iteratively adjust, as noted above. The image sensor model may also incorporate further data that may be known and/or measured with respect to the operation of the image sensor 320. For instance, the image sensor model may be generated in this manner using, in addition to the image sensor performance profile dataset, data from the sensor's datasheet and documentation, measured sensor data during operations, etc. The sensor model may be generated in this manner using any suitable machine learning techniques, such as deep learning techniques, for instance, such that the sensor model may generate synthetic sensor data that closely resembles the real-world data generated by the image sensor 320 under similar conditions. Thus, such a sensor model may be generated by using the image sensor performance profile dataset as part of a training dataset that may optionally include other sensor data, e.g. data obtained vias operation of the image sensor 320.

Additionally, the process flow 500 comprises modifying (block 514) a vehicle-based operation based upon the output of the sensor model. Thus, once the sensor model is generated (block 512), the sensor model may be deployed as part of the safety system 200 of the vehicle 100 for instance. This may include storing the sensor model in one or more of the memories 202, which may then be accessed by the AV/ADAS system of the vehicle 100, and the output thereof implemented to modify the various vehicle-based functions that may be performed by the AV/ADAS system as discussed above. As an illustrative example, the outputs of such a sensor model may be utilized to provide a 2-dimensional look up table, for instance, that may, in turn, be input to a further model to realize this implementation. The image sensor model may be configured to output data that may be used for various purposes (e.g. to cause modification of a vehicle-based operation), which is discussed in further detail below with respect to various scenarios.

### V. Interpretation the Image Sensor Performance Profile Dataset

Again, the image sensor performance profile dataset may comprise CDP measurements of images acquired via the image sensor 320 over a range of any suitable combination of parameters that are varied to acquire these measurements, as noted above. Thus, not only may the image sensor performance profile dataset be used to generate a sensor model as noted above, but it may additionally or alternatively be stored by the computing device 301 and/or the AV/ADAS system of the vehicle (e.g. in the one or more memories 202) and subsequently accessed in various ways to yield valuable information regarding the operation of the image sensor 320 during its operation. For instance, an image sensor performance profile dataset may be acquired for various image sensors and used to compare their performance across a variety of operating conditions. As another example, the image sensor performance profile dataset may be leveraged to provide performance data regarding the operation of the image sensor 320 under various operating conditions, and thus may be used a guide to evaluate the image sensor's performance and suitability for a particular application. In other words, if the imager performance is not optimized yet (or it is misconfigured) this may be determined early in the evaluation process. A further example, the measurement results may be compared against the expected performance of the sensor based on knowledge of the device, models of the imaging components, etc., in which unexpected results may indicate a sensor issue.

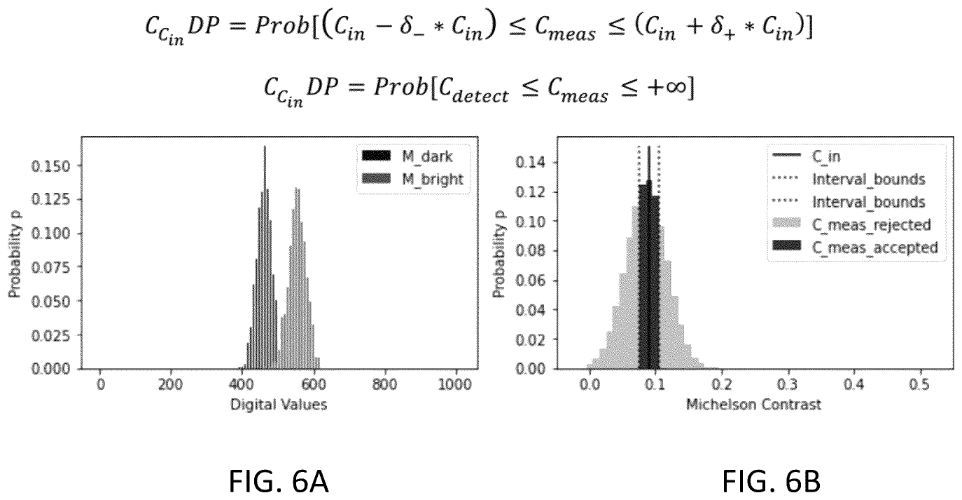

To provide some illustrative examples, FIGS. 6A and 6B illustrate example performance plots that are derived from the image sensor performance profile dataset that has been generated in accordance with the process flow 500. To this end, it is noted that the x axis for the plot shown in FIG. 6A represents a range of illumination values, whereas the y axis represents a probability value for a particular contrast and confidence interval (CI). Thus, FIG. 6A may provide data regarding the probability of detecting an object at a specific contrast across an entire range of light levels.

With reference to FIG. 6B, the x axis represents a range of contrast target values, whereas the y axis represents a probability value for a particular contrast target value and CI. Thus, FIG. 6B may provide data regarding the probability of detecting an object for a specific confidence interval across various contrast target values.

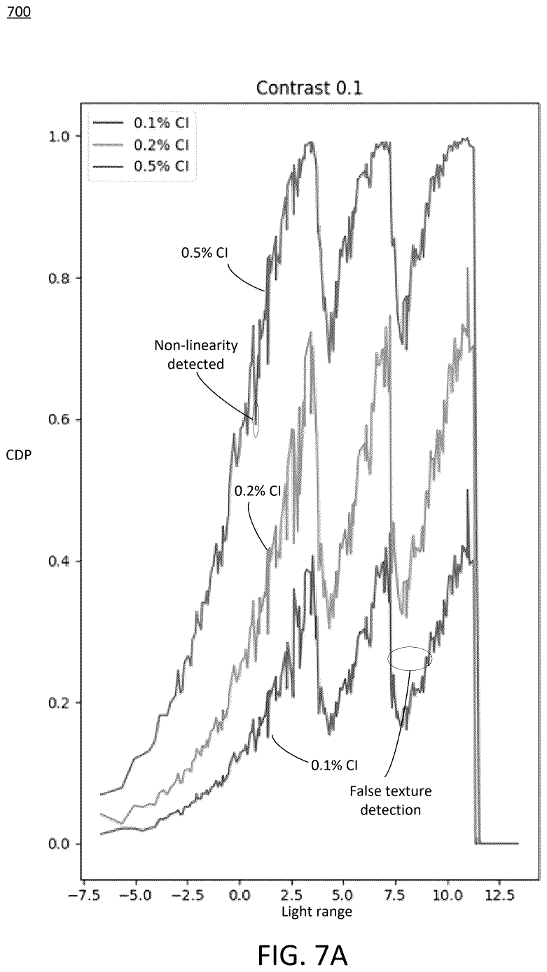

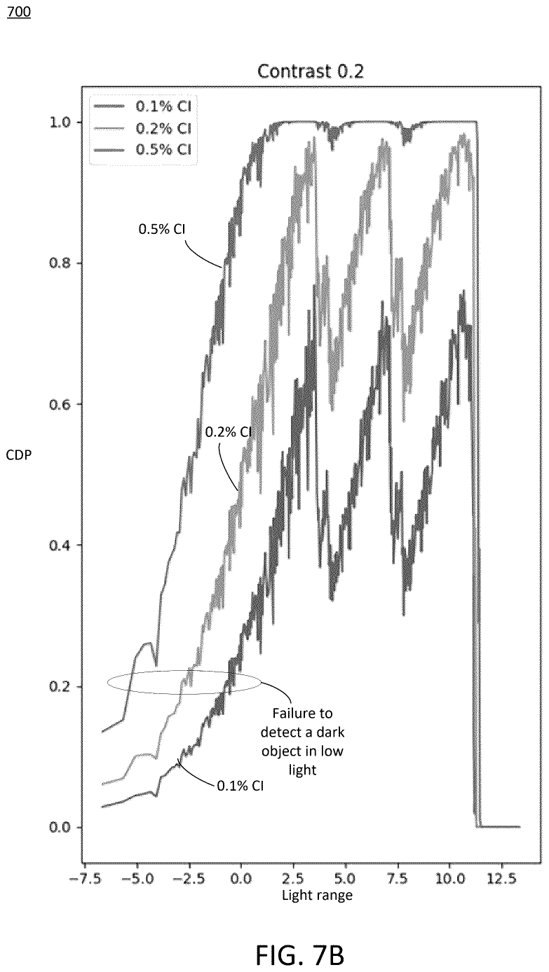

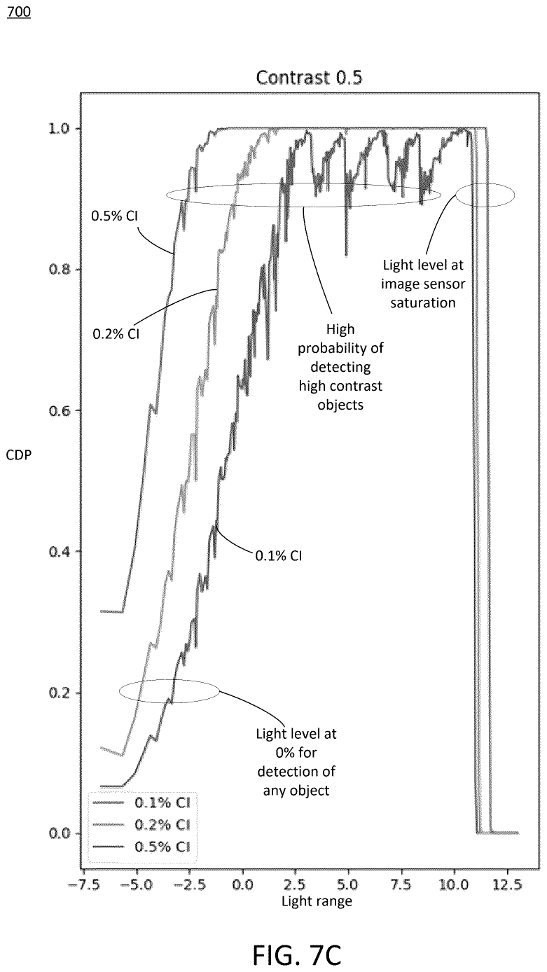

FIGS. 7A-7C illustrate plots of CDP versus light range for different contrast targets corresponding to 0.1, 0.2, and 0.5, respectively. The light range as discussed herein may be expressed in terms of illuminance or lux, as this represents an amount of light falling on the sensor. This may then be used to understand the sensor or camera response to that light level, as noted herein. The plots as shown in FIGS. 7A-7C represent the CDP represented across light levels for a single exposure. Each of the plots as shown in FIGS. 7A-7C may illustrate, for each contrast target and exposure value, a CDP versus light range trace for a set of confidence intervals corresponding to 0.1%, 0.2%, and 0.5%, as shown via the inset and corresponding trace labels. The image sensor performance profile dataset may be leveraged to generate such plots, which provide valuable information regarding the performance of the image sensor 320 under various conditions.

For instance, the CDP traces as shown in FIG. 7A may identify the light level associated with a false detection of textures or the identification of non-linearities. As another example, the plot shown in FIG. 7B illustrates the CDP for low light levels that results in a failure to detect dark objects in low light. As yet another example, the plot shown in FIG. 7C illustrates the light levels required to detect an object based upon the CDP at those light levels, as well as the high probability of detecting high contrast objects over a range of light levels. The light level at image sensor saturation is also shown in FIG. 7C as an example, which indicates that saturation will occur for a specific threshold light level.

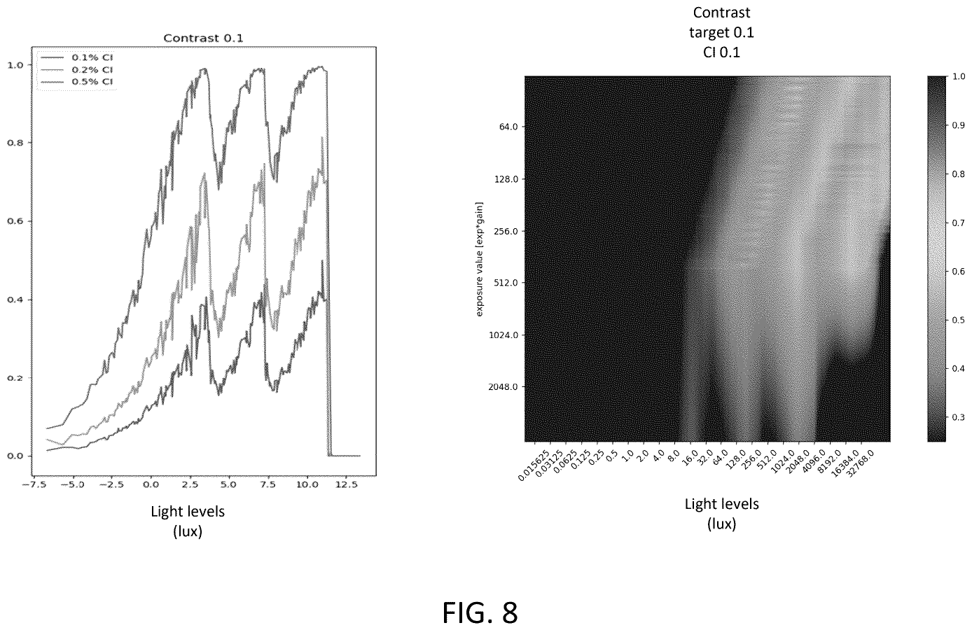

FIG. 8 illustrates a CDP versus light level plot and a 2D heatmap that maps the CDP values represented in the image sensor performance profile dataset across a set of different light levels and exposure values. Thus, the plot of FIG. 7A is shown as an example on the left side of FIG. 8, which again illustrates the CDP for a set of CIs across a range of light levels at a single exposure value for a contrast target of 0.1. However, by repeating the measurements as discussed above with respect to the process flow 500 over a range of exposure values, the image sensor performance profile dataset may contain the CDP measurements performed across a range of light levels repeated for each exposure value. This enables the generation of a 2D heatmap plot as shown in FIG. 8, which illustrates the CDP mapped to a range of both light levels and exposure values as shown for a contrast target of 0.1 and a CI of 10%. Thus, the values identified with the intersection of the exposure values and light levels in FIG. 8 represent a corresponding CDP value for the image sensor 320 at those specific exposure values and light levels. In this example, the CDP metric is shown as being represented from 0-1 (or 0% to 100%).

The 2D CDP heatmap is thus useful to identify the overall performance of the image sensor 320. For instance, the 2D CDP heatmap as shown in FIG. 8 illustrates a particular region (in terms of light levels and exposure values) where contrast detection beings to improve. With respect to the 2D CDP heatmap as shown, it may be observed that exposure values less than 256 and light levels greater than 16 result in a steady increase of the CDP. Furthermore, light saturation levels, noise levels, and non-linearities may be identified that cause “gaps” in the CDP for specific combinations of lower exposure values and higher light levels.

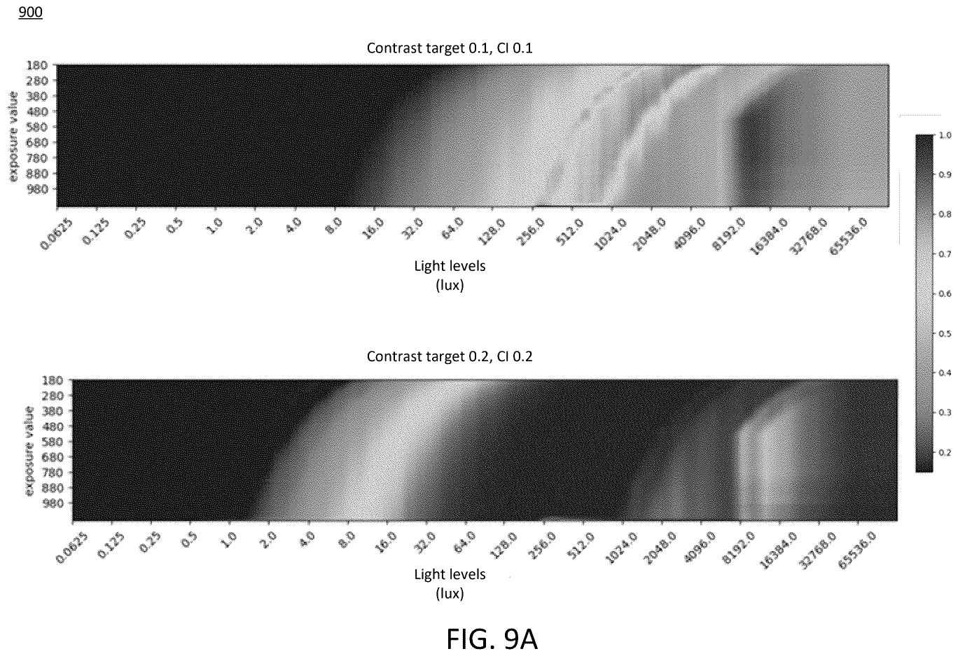

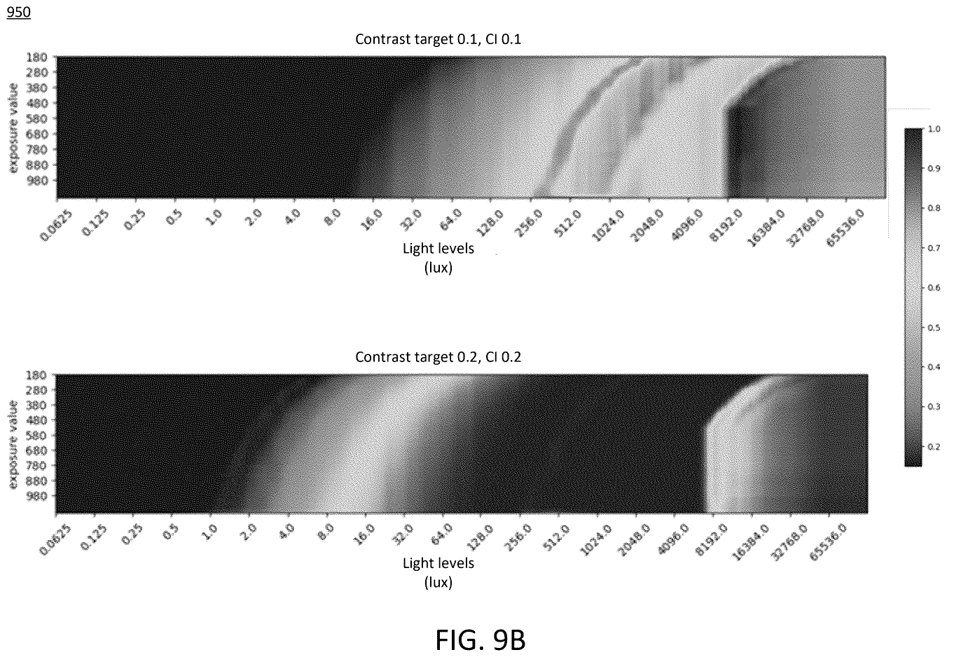

The generation of a 2D CDP heatmap for a set of contrast targets and CIs also allows the performance of different sensors to be compared in an objective and standardized manner. For instance, FIGS. 9A-9B illustrate example 2D CDP heatmaps that plot a probability of a specified contrast detection within a specified confidence interval over a range of exposure values and light levels for two different image sensors, in accordance with one or more aspects of the present disclosure. FIG. 9A illustrates two example 2D CDP heatmaps for a first sensor, whereas FIG. 9B illustrates two example 2D CDP heatmaps for a second sensor. In this example, the first image sensor corresponding to the 2D CDP heatmaps of FIG. 9A comprises an a first 8.3 MP automotive image sensor, whereas the second image sensor corresponding to the 2D CDP heatmaps of FIG. 9B comprises a second 8.3 MP automotive image sensor. The upper CDP heatmap in each of FIGS. 9A and 9B corresponds to a contrast target of 0.1 and a CI of 10%, whereas the lower CDP heatmap in each of FIGS. 9A and 9B corresponds to a contrast target of 0.2 and a CI of 20%. Thus, in the event that the tested parameters included contrast targets of 0.1, 0.2, and 0.5, as well as CIs of 10%, 20%, and 50%, the two 2D CDP heatmaps as shown in FIGS. 9A and 9B may represent 2 of 9 total 2D CDP heatmaps that may be generated from the image sensor performance profile dataset of each respective image sensor. However, for purposes of brevity and ease of explanation, only two example 2D CDP heatmaps are shown.

From a comparison of these two 2D CDP heatmaps for each of the two different image sensors, the heatmaps appear to be similar with the exception of slight differences being visible. Of course, the 2D CDP heatmaps may be compared in a numeric manner by computing the CDP values for each point in each of the heatmaps to provide a direct comparison of this metric for the same operating conditions between the two different sensors. In this way, the generation of the image sensor performance profile dataset as discussed herein may facilitate an automated and empirical process for benchmarking, measuring, and/or comparing image sensor performance over a range of expected operating conditions.

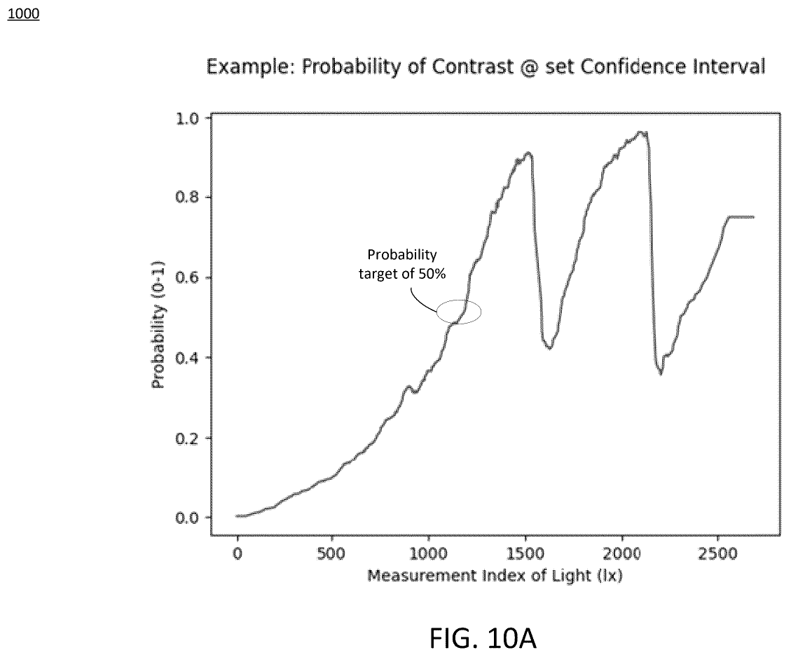

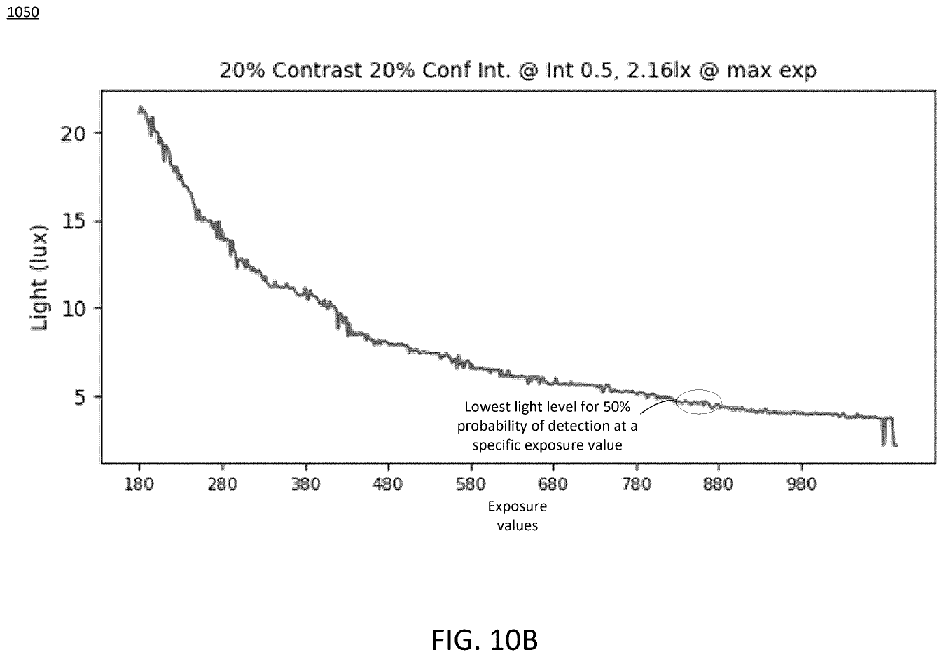

FIGS. 10A and 10B illustrate example plots that may be generated from the image sensor performance profile dataset of the image sensor 320 to determine low light performance. For instance, FIG. 10A illustrates a plot of CDP versus a range of light levels for a specific contrast target and CI. By repeating the CDP measurements as discussed above with respect to the process flow 500 (block 506), the image sensor performance profile dataset may include CDP measurements acquired over a range of exposure values and light levels of the image sensor 320. Thus, the plot as shown in FIG. 10B provides a light range versus CDP value plot for a specific contrast target and CI, which are both 20% in this example. Thus, FIG. 10A illustrates that a minimum light level of about 1200 lux is required to achieve a corresponding contrast detection probability of 50%. Moreover, the plot as shown in FIG. 10B illustrates that the lowest light level for a 50% CDP at a specific exposure value of about 850 corresponds to a light level of about 5 lux.

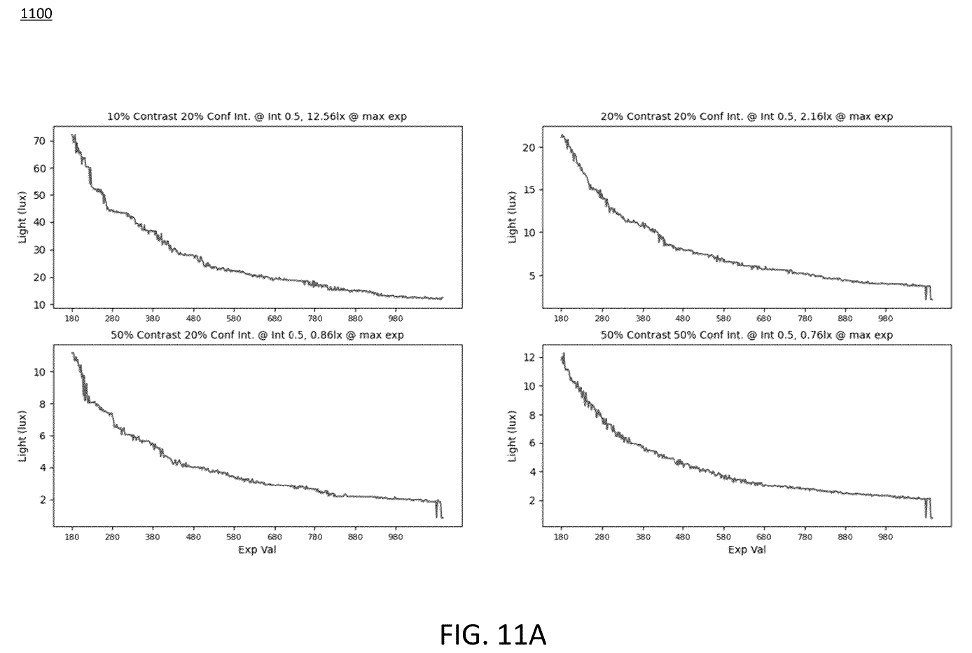

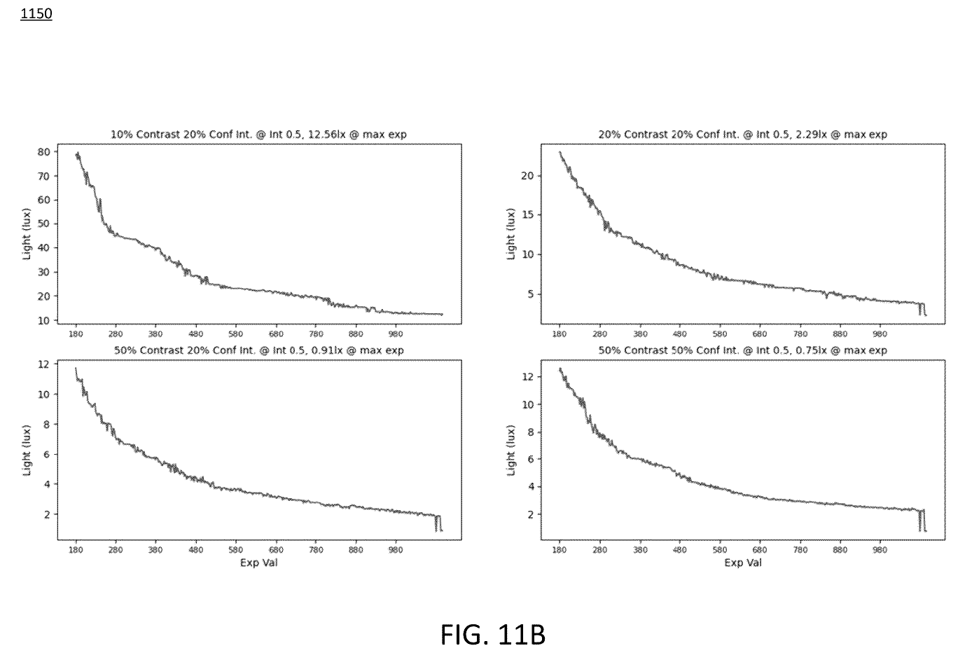

FIGS. 11A and 11B illustrate sets of plots for the two different image sensors as discussed above with respect to FIGS. 9A and 9B. The plots as shown in FIG. 11A correspond to light level versus exposure value plots that are generated using the image sensor performance profile dataset of the first 8.3 MP automotive image sensor. The plots as shown in FIG. 11B correspond to light level versus exposure value plots that are generated using the image sensor performance profile dataset of the second 8.3 MP automotive image sensor. Each set of plots includes a set of four light level versus exposure value plots, one per different combination of contrast target and CI as shown.

Each of the plots as shown in FIGS. 11A and 11B illustrates that an intercept tracking technique may be used to determine the light level required to reach a 50% CDP for a corresponding contrast target of 10%, 20%, or 50% in this example. Thus, for the plots of the first 8.3 MP automotive image sensor as shown in FIG. 11A, similar light levels of 12.56 lux, 2.16 lux, 0.86 lux, and 0.76 lux are the lowest possible light levels across possible sensor exposure values to reach a 50% CDP for each of the contrast target scenarios as shown. Moreover, for the plots of the second 8.3MP automotive image sensor as shown in FIG. 11B, similar light levels of 12.56 lux, 2.29 lux, 0.91 lux, and 0.75 lux are required to reach a 50% CDP for each of the contrast target scenarios as shown.

That is, a light level required for 50% CDP across settings at the highest exposure is the same between the two image sensors, and sensitivity/noise is similar between these two image sensors as well. In other words, both sensors show better performance at the highest exposure in this scenario. Upon further analysis of these results, it is noted that this is due to each sensor supporting two separate modes: a normal mode that operates best for low light performance, and a secondary mode that provides better HDR noise at the expense of worse low light performance. Thus, these plots confirm that the control scheme implemented for both sensors works as was expected and utilizes the secondary mode with the exception of the highest exposure.

### VI. Incorporation of Color Ratio Data Into the Image Sensor Performance Profile Dataset

Again, the image sensor performance profile dataset may include CDP measurements that are performed over a range of various parameters. In the example provided above, the CDP measurements were performed by varying the contrast target, confidence interval, exposure values, and light levels as the image sensor 320 acquired images of the pattern 340. In additional embodiments, which are discussed in greater detail in this Section, color ratio data measurements may also be included as part of the image sensor performance profile dataset, and thus such measurements may be performed with the CDP measurements as discussed in block 506 of the process flow 500.

To do so, each patch in the image of the pattern 340 may be analyzed to determine an average color value across all pixels in each patch. The number and type of color values that are averaged in this manner may be a function of the particular color filter array (CFA) that is implemented by the image sensor 320. For instance, the pattern 340 is shown in FIG. 4 as including 36 different patches having different contrast levels with respect to one another, as noted above. In accordance with the present embodiments, for a particular set of dominant color values (e.g. yellow 1, yellow 2, red, and cyan) an average color value may first be computed from all of the pixels in each respective patch (or any predetermined subset of less than all pixels thereof).

Thus, continuing this example, for the pattern 340 as shown in FIGS. 4, 36 average yellow 1 (Y1) color values, 36 average yellow 2 (Y2) color values, 36 average red (R) values, and 36 average cyan (Cy) values may be computed. In this way, each patch is identified with a respective average red color, two average yellow colors, and an average cyan value color. In other words, for each of the different portions of the image of the pattern 340 (e.g. the different patches), an average color value for each one a set of different colors is calculated.

Next, color ratio data is calculated from each combination of these average color values. That is, “per-patch” color ratios are calculated by computing the ratio of each combination of the average colors in each respective patch to one another. For instance, and continuing the previous example, a color ratio may be computed for Y1/Y2, Y1/R, Y1/Cy, Y2/R, Y2/Cy, and R/Cy. Of course, a lesser number of color ratios may alternatively be calculated. In any event, this may include repeating the color ratio measurement for each one of the plurality of images for different light levels of the pattern 340 and different exposure values of the image sensor 320 to generate the image sensor performance dataset. As a result, the image sensor performance dataset may further provide color ratio data for different light levels and exposure values, in addition to the CDP values as discussed above.

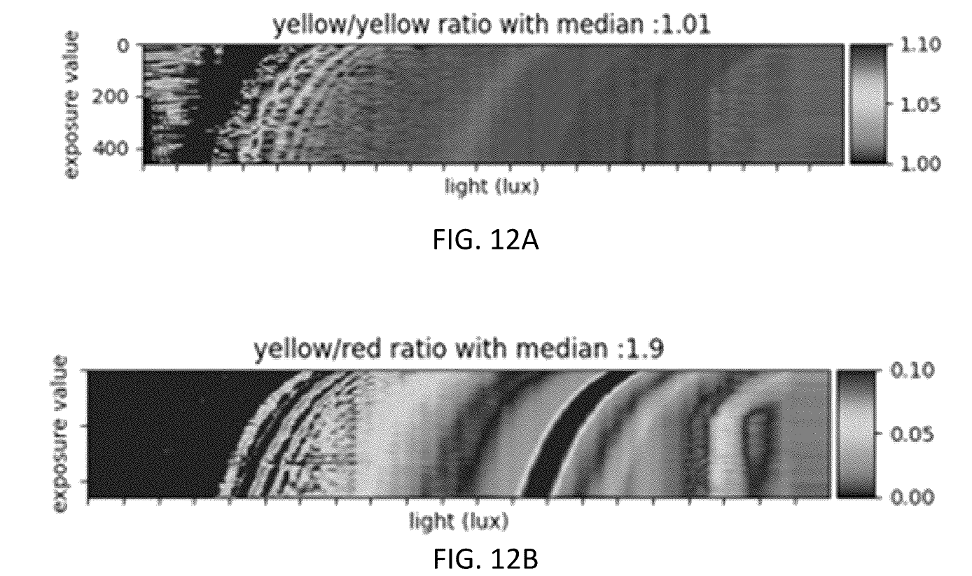

The measurement of the color ratio values across a range of different light levels and exposure values in this manner may be leveraged to generate a resulting 2D color ratio heatmap in a similar manner as discussed above with respect to the 2D CDP heatmaps. However, in this case, the 2D color ratio heatmap will show the areas in the image where the color response could change. To provide an illustrative example, reference is now made to FIGS. 12A-12B, which illustrate, for a particular patch in the image of the pattern 340, two separate 2D color ratio heatmaps that represent example color ratio values over a range of exposure values (in the y-axis) and a range of light levels (in the x-axis). Thus, the intersection of the exposure values and light levels in each 2D color ratio heatmap provides the resulting color ratio values between two average colors in a patch.

For example, FIG. 12A represents an example 2D color ratio heatmap in which the intersection of the exposure value and light levels provides the resulting color ratio values between the two average yellow color values in a patch over a range of exposure values and a range of light levels. As another example, FIG. 12B represents an example 2D color ratio heatmap in which the intersection of the exposure value and light levels provides the resulting color ratio values between the yellow and red average color values in a patch over a range of exposure values and a range of light levels. From this information, an expected error of color ratios may be observed to evaluate the color response of the image sensor 320.

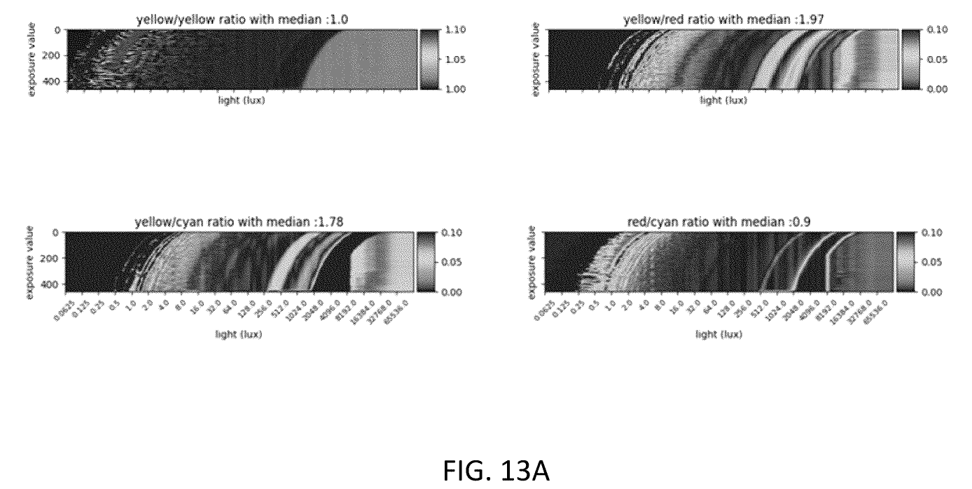

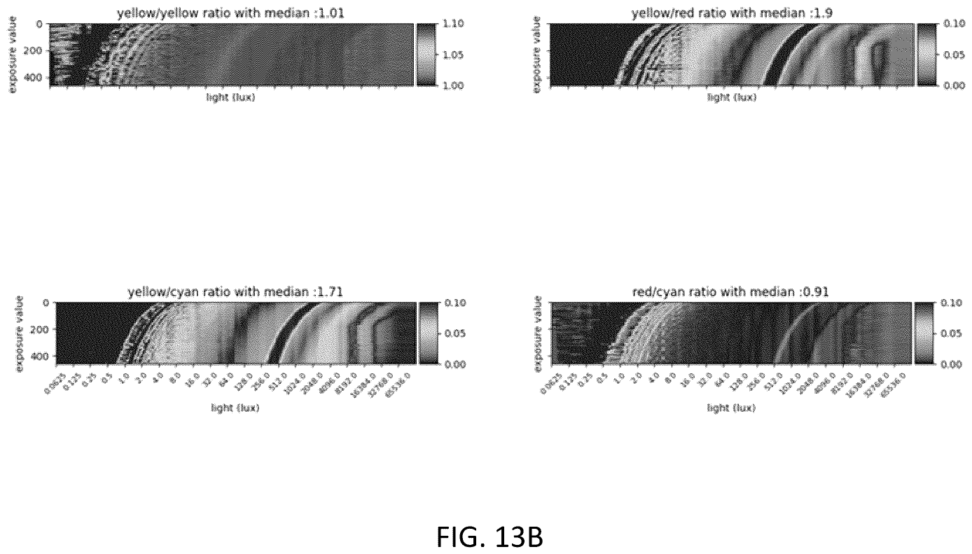

To provide additional examples, reference is now made to FIGS. 13A-13B. Each of the four 2D color ratio heatmap as shown in FIGS. 13A and 13B represents a different color ratio value mapping, with a different color ratio value being represented in each map, for a range of exposure values and a range of light levels. The 2D color ratio heatmaps as shown in FIG. 13A correspond to the first 8.3MP automotive image sensor, whereas the 2D color ratio heatmaps as shown in FIG. 13B correspond to the second 8.3MP automotive image sensor. A comparison of these 2D maps thus illustrates that the median color ratios for both sensors are similar, although the color responses vary differently between the sensors across different light levels. In the example as shown in FIGS. 12 and 13, the sensor using a small and large photodiode within the pixel structure (referred to as a “split-pixel photodiode”) shows changes in the color response (measured by color ratio) at the point in the HDR response where the large photodiode (being more sensitive) has saturated, while the smaller photodiode (with a difference in color response) is the dominant detector within the pixel structure. Such results may be particularly useful, for instance, to identify where a minor (but noticeable) change in the detection of color in the response range of the camera may exist.

The process flow 500 thus describes an overall process that may be used to generate an image sensor performance profile dataset for each image sensor that is profiled in this manner. The image sensor performance profile dataset may then be used in various ways, as discussed in further detail herein. For instance, any of the portions of the image sensor performance profile dataset as discussed herein may be compared to a corresponding set of predetermined thresholds that may be used as part of an image sensor test and/or certification procedure. For instance, a set of reference 2D CDP heatmaps, reference 2D color ratio heatmaps, etc., may be generated having tabulated reference data points for various exposure values, light levels, contrast targets, confidence intervals, temperatures, etc. The data points from these reference 2D maps may represent threshold values with respect to an expected performance of a particular image sensor, and may be compared to the 2D heatmaps obtained from the image sensor performance profile dataset. In this way, the operation of image sensors may be verified prior to their installation and use in a vehicle by way of a comparison of the empirical data derived from the image sensor performance profile dataset to such reference datasets. Additionally, the image sensor performance profile dataset may be implemented in accordance with various applications in the context of the vehicle's AV/ADAS system, as discussed in further detail below.

### VII. Using the Image Sensor Performance Profile Dataset for AV/ADAS Applications

Again, an image sensor model may be generated from the image sensor performance profile dataset, and this model may be implemented as part of the safety system 200 of the vehicle 100. Although described herein in terms of a single image sensor model, it will be understood that the image sensor model as described herein may comprise several image sensor models that form part of an overall image sensor model construction. For instance, a separate image sensor model may be generated from the image sensor performance profile dataset for a range of light levels and/or exposure values over which the data was measured to generate the image sensor performance profile dataset.

The image sensor 320, as well as the corresponding image sensor model and/or the corresponding image sensor performance profile dataset, may also be deployed as part of the vehicle 100. The image sensor model and/or the corresponding image sensor performance profile dataset may be utilized by the AV/ADAS system of the vehicle 100 to modify various vehicle-based operations in conjunction with images acquired via the image sensor 320. For instance, the vehicle 100's AV/ADAS system may be identified, for example, with the safety system 200 as discussed above and/or components thereof. Thus, the AV/ADAS system may be referred to herein as performing various vehicle-based functions, which may include the execution of CV algorithms (which may include machine vision based object or feature classification processes) and/or the execution of other suitable functions that may control one or more processes performed by the vehicle 100. This may be achieved, for example, via the one or more processors 102 of the safety system 200 executing instructions stored in a suitable memory, such as a local memory of the one or more processors 102, the one or more memories 202, etc., as noted above.

Thus, the vehicle 100's AV/ADAS system may receive the images generated via the image sensor 320 during operation of the vehicle 100, an output of the image sensor model, as well as any images and/or other data generated via additional sensors (e.g. lidar, radar, etc.) that may be implemented as part of the safety system 200, and use these various inputs to perform any suitable vehicle-based functions as discussed in further detail herein. To do so, the AV/ADAS system may transmit controls, instructions, commands, etc., to any suitable components of the vehicle 100, which may in turn control the operation of one or more vehicle-based operations in accordance with the embodiments as discussed herein.

For instance, the image sensor 320 may be implemented as one of the image acquisition devices 104, as discussed above with respect to the vehicle 100. As part of this implementation, the image sensor model may be provided with the same inputs as the image sensor 320 during operation, and the output of the image sensor may be used as an expected value and the AV/ADAS system compare these outputs to the actual output of the image sensor 320 during operation. As another example, the image sensor model may generate simulated data for specific operating conditions that match the current operating conditions of the image sensor 320 during operations, and then the AV/ADAS system may compare the simulated results to the output of the image sensor 320. Thus. the comparison of the image sensor model outputs and the actual outputs of the image sensor 320 via the AV/ADAS system may be performed, for example, using the output of an image sensor model having the same operating conditions (e.g. the same light levels and/or exposure values) as the current operation of the image sensor 320.

In any event, the comparison of the output of the image sensor model to the output of the image sensor 320 may be used to perform or to modify the performance of a vehicle-based operation of the vehicle 100. For instance, if an output of the image sensor model and the image sensor 320 deviate from one another with respect to one or more metrics (e.g. CDP, color value ratios, etc.) in excess of a corresponding predetermined threshold value, then the AV or ADAS system may trigger a specific vehicle-based operation, which may include generating an error or warning, issuing an audible and/or visual alert in the vehicle, etc. Additional examples and scenarios regarding how the vehicle-based operations may be modified are discussed immediately below. As one illustrative example, a road-book model implemented via the vehicle 100's ADAS/AV system may be expected to detect a road in front of the vehicle 100. The sensor model may indicate that, for a particular sensor exposure level and input light-level, the road should be detectable. Thus, it may be determined that a failure to detect a road surface should trigger a warning to the functionality of the sensor in the camera.

Again, embodiments include leveraging the image sensor model and/or the image sensor performance profile dataset to modify a vehicle-based operation, which may be done for instance in response to the output of the image sensor model and/or a comparison of the output of the image sensor model with an image output via the image sensor 320. For instance, during operation of the vehicle 100, the image sensor 320 may acquire images of the environment, which may be used in accordance with any suitable machine vision based object or feature classification algorithms implemented via the safety system 200, as discussed herein. Embodiments include modifying any suitable portions of this machine vision based object or feature classification process based upon a comparison of conditions under which the image sensor 320 acquired the images during operation and an output of the image sensor model for the same conditions (e.g. the same light levels and/or exposure values).

As one example, the images acquired via the image sensor 320 may be with respect to a particular scene that represents a view of an environment while the vehicle 100 navigates that environment. Thus, the images acquired via the image sensor 320 may be used to perform object or feature classification with respect to this scene. This may include, for example, classifying a road object such as a pedestrian or another vehicle, identifying a road sign or road feature, etc.

Continuing this example, as part of this classification process, color values of the acquired images may be utilized as part of a CV algorithm implemented by the AV/ADAS system to identify a specific type of traffic signal (e.g. green, yellow, and red stop lights). And because the image sensor performance profile dataset includes data measured over various regions of an acquired image (e.g. the patches of the pattern 340), the output of the image sensor model may also be analyzed with respect to a specific location within an image acquired by the image sensor 320. Thus, a CV algorithm may initially identify a red light at a specific region within an image acquired via the image sensor 320. However, it is now assumed that a comparison between the output of the image sensor model and the image sensor 320 indicates that, for this same region of an acquired image, light levels, and exposure values, one or more color ratio values deviate from a predetermined threshold color ratio value. In this scenario, the AV/ADAS system may issue a warning, switch from autonomous to manual control of the vehicle, etc.

As another example, it is noted that when color ratio data is included in the image sensor performance profile dataset, which again includes color ratio values at different regions of an image being mapped to both exposure values and light levels, this allows the computing device 301 or AV/ADAS system, as the case may be, to generate a mapping of color-accuracy to each exposure and light level. Thus, the AV/ADAS system (e.g. a CV algorithm implemented via the same) may use this color ratio mapping data to adjust the confidence of color detection determinations. For instance, the AV/ADAS system may verify, from the output of the image sensor model, whether an expected error for a set of current operating parameters (e.g. exposure and light level) is outside a predetermined color ratio error range the CV algorithm may use to classify a color. Thus, when the measurement error is outside this predetermined color ratio error range, the CV algorithm may classify the color detection as failed.

The vehicle-based function that is executed via the AV/ADAS system of the vehicle 100 may be triggered in response to any suitable events or decisions that are determined from the image sensor performance profile dataset and/or the output of the image sensor model as discussed herein. For instance, as noted above, the AV/ADAS system of the vehicle 100 may determine from the output of the image sensor model that, for a current exposure value and light level, the measurement error is outside this predetermined color ratio error range. Thus, the AV/ADAS system may anticipate that subsequent color classifications may fail, and the AV/ADAS system may modify the exposure value implemented via the image sensor 320 for subsequent image acquisition. This adjustment may include, for instance, changing the exposure value of the image sensor 320 to a level at which a particular object may then be measured with a lower (e.g. acceptable) color ratio error based upon the adjusted parameters.

As another example, the computing device 301 or the AV/ADAS system, as the case may be, may generate a mapping of CDP data values to each exposure and light level, as noted above. Thus, the AV/ADAS system may also modify a vehicle-based function based upon the output of the image sensor model, which in this example may identify the CDP for a current exposure and light level. The AV/ADAS system (e.g. the CV algorithm) may then adjust a likelihood of a classification of a particular object that is detected from images acquired via the image sensor 320 at the same exposure value and light level implemented by the image sensor model.

As an illustrative example, the CV algorithm may decrease the likelihood of classification of features and/or objects (e.g. a road context such as road texture or objects) that relies more heavily upon differentiating between contrast values in the image, and thus requires a particular threshold CDP to ensure this result. And, as noted above for the use of the color ratio data, the CV algorithm may additionally or alternatively adjust one or more parameters used by the image sensor 320 (e.g. an exposure setting) to acquire subsequent images for this purpose, such that the classification of a road context or object now appears within a range that was measured to have a lower error as indicated in the image sensor performance profile dataset.

Additionally, because CDP data is available across a wide range of exposure settings and light levels, the output of the image sensor model may be particularly useful to identify acquired images that are better suited for analysis via the CV algorithm for classification and detection. For instance, the image sensor 320 may generate multiple images, each having a different exposure value, which is commonly the case for HDR imagers. Alternatively, the image sensor 320 may be from among several image sensors in the vehicle 100, each providing images to the AV/ADAS system. In any event, such images may be acquired in accordance with different exposure values, and the AV/ADAS system may receive such images simultaneously or nearly simultaneously. In such a scenario, the AV/ADAS system may use the output of the image sensor model to determine, for each image having a different exposure value, which image has a higher CDP and/or a lower color error. In response, the AV/ADAS system may then select the image with the exposure value associated with the acquired images that are identified, from the image sensor model output, having the preferred metrics (e.g. higher CDP and/or a lower color error) for use by the CV algorithm.

As another illustrative example, the CDP data may additionally or alternatively be implemented as part of a redundancy feature that may be present in the vehicle 100. For instance, the safety system 200 of the vehicle 100 may comprise a safety architecture in accordance with a self-driving system (SDS). However, like all complex systems, such safety architectures may experience failures related to hardware, software bugs, perception failures, planning failures, actuation failures, adversarial disruptions, etc.

To address such failures, the safety system 200 may comprise a Primary-Guardian-Fallback (PGF) fusion system, which may implement any suitable number of different independent or overlapping sensor systems, the output of which may be utilized to CV algorithm processing and/or to determine the various vehicle-based functions that are to be executed by the vehicle 100 such as object detection, classification, trajectory planning, actuation, other vehicle-based functions as discussed herein, etc. For example, the safety system 200's primary system may implement the one or more lidar sensors 112, whereas the safety system 200's fallback system may implement the one or more radar sensors 110. Of course, this is but one example, and the primary and fallback systems may implement different sensors, which may be independent of one another or overlap with one another, in various embodiments.

In any event, the primary and fallback systems of the safety system 200 may output independent data streams, and the safety system 20 may also implement separate models (e.g. SDMs) per each data stream/system. Furthermore, as part of such a PGF fusion system, the guardian system may function as a binary system that outputs a Boolean value that is indicative of whether the output of the primary or the fallback system is the “better” choice. For instance, the guardian system may output a ‘1’ if the primary system output is better than the fallback system, and a ‘0’ otherwise. Thus, the output of the guardian system controls which output and/or model is used by the safety system 200. In this context, “better” may be determined based upon any suitable metrics, which may be detected, measured, identified, etc. in the primary and fallback systems. This may include, for example, the identification of failures and/or errors in one of the primary or the fallback system, a determination that one of the primary or fallback system is outputting data that is producing inaccurate or inconsistent results, etc. Additionally or alternatively (which may include the use of the PGF system or an alternate redundancy system), a comparison may be made among both data streams, with an agreement between these different sensors (and optionally other data sources such as the REM map data for instance) being leveraged to make decisions and/or determine the vehicle-based functions.

As part of the operation of the PGF or another alternate redundancy system, embodiments include leveraging the CDP data from one or more sensors within the primary and/or fallback system to facilitate a determination regarding whether the output of the primary or fallback system should be implemented. For example, when the primary system is not providing good results (e.g. based on a comparison to a predetermined threshold, a history of outputs, etc.) via the one or more lidar sensors 112, the PGF system may rely on the fallback system output that utilizes the one or more radar sensors 100, as noted above. For an alternate redundancy system, the CDP data from one or more sensors may be implemented to determine whether an agreement is reached between the outputs of each system.

As a further example, the output of the image sensor model may be utilized to perform specific predetermined vehicle-based functions in response to an anticipated value that is obtained from the image sensor performance profile dataset. For instance, one or more parameters of the image sensor 320 (e.g. temperature, exposure settings, light levels, etc.) may be used to determine a corresponding CDP, color ratio, etc., of images acquired by the image sensor 320 in accordance with these same parameters. Thus, and continuing this example, when a CDP is predicted in this manner for images acquired via the image sensor 320 that is less than a predetermined threshold value, the AV/ADAS system may identify such a CDP as being too low to be used for one or more predetermined critical use cases for images acquired under these conditions. For instance, the AV/ADAS system may determine that, for a specific combination of exposure values and light levels, the resulting CDP is too low, such that pedestrians under these conditions can no longer be accurately identified. In such a scenario, the AV/ADAS system may cause the vehicle 100 to execute specific vehicle-based functions to avoid the use of the CV algorithms that rely on such acquired images. This may include, for instance, stopping the car on the side of the road, instructing the driver to take over manual control of the vehicle, disregarding images acquired via the image sensor 320 and relying instead on other sensor inputs such as lidar and/or radar, etc. for use by the CV algorithms.

Furthermore, the AV/ADAS system may also gather statistics during operation, which may include data regarding various objects within a scene and/or at a particular geographic location. The AV/ADAS may compare such statistics with output of the image sensor model to identify or predict malfunctions in the image sensor 320. For instance, the AV/ADAS system may aggregate and store statistics with respect to regions within acquired images having a known identity, which may be profred e.g. using Roadbook map data of the location as discussed above. The AV/ADAS system may then compare any suitable known metrics obtained in this manner, such as a color ratio of objects in the scene, for instance, to the color ratio data obtained from the CV algorithms to identify if the camera has malfunctioned.

As an illustrative example, it is assumed that the Roadbook map data indicates the location of an upcoming red traffic light, and the location of the traffic light is then identified within an image acquired via the image sensor 320 (or another sensor). The AV/ADAS system may then measure the color ratios of the pixels within the traffic light to determine whether the color ratios match an expected red color value. If a predetermined number of such pixels correspond to color information that does not align with red (or a high color ratio error is detected for the red color for this predetermined number of pixels), then the AV/ADAS system may determine that the image sensor 320 was operating incorrectly. In response, the AV/ADAS system may perform one or more vehicle-based functions, such as for instance disabling the image sensor 320 and/or take corrective actions such as for example stopping the vehicle on the side of the road, instructing the driver to take over manual control of the vehicle, etc., to avoid such faulty image data causing an unsafe condition.

As another illustrative example, the one or more vehicle-based functions may comprise adjusting the machine vision based object or feature classification process of the CV algorithm to reduce the probability of classification of the traffic signal. Again, it is noted that the image sensor model used for this comparison may be generated in accordance with the same conditions under which the image sensor 320 is operating when such images are acquired. Thus, the machine vision based object or feature classification process may be adjusted in this way based upon a location of the object or feature in the acquired images, as well as other parameters that are common between the image sensor model and the image sensor 320, e.g. the exposure value and/or light levels of the image sensor 320 when the images were acquired.

Additionally or alternatively, the machine vision based object or feature classification process of the CV algorithm may be adjusted to prevent detecting and/or classifying features and/or objects in acquired images when a deviation between an output of the image sensor model and the image sensor 320 in excess of a predetermined threshold value is detected. For instance, and using the above-referenced example of color ratio values, the CV of the AV or ADAS system of the vehicle 100 may avoid using the acquired image data and/or regions within the acquired image data to detect traffic lights, as it is anticipated that such classifications would be unreliable.

Additionally or alternatively, if a CDP deviation is identified between an output of the image sensor model and the image sensor 320 in excess of a threshold value, then the CV of the AV or ADAS system of the vehicle 100 may avoid using the acquired image data and/or regions within the acquired image data to detect features that rely on the use of contrast differentiation. This implementation may be particularly useful, for example, to prevent the detection of false positives via the AV/ADAS system.

As yet another illustrative example, instead of the color information being used as described above, the statistics gathered may be with respect to CDP data. In other words, the AV/ADAS system may compare the expected contrast detection of an object in a scene to the CDP probability output from the image sensor model and/or derived from the image sensor performance profile dataset. For instance, a different sensor (e.g. radar) may identify an object in a scene that is expected to have a high contrast (e.g. another vehicle in front of the vehicle 100). The AV/ADAS system may then calculate the difference in mean pixels of this other vehicle to the pixels outside the other vehicle to calculate the contrast between both. Then, if the contrast is less than a predetermined threshold value, and the image sensor model output for the same corresponding conditions (e.g. the same light level, exposure value, temperature, etc.) indicated that the CDP was expected to be higher than this predetermined threshold value, the AV/ADAS system may perform one or more vehicle-based functions. This may include, for instance, disabling the image sensor 320 and/or taking corrective actions such as for example stopping the car on the side of the road, instructing the driver to take over manual control of the vehicle, etc., to avoid such faulty image data causing an unsafe condition.

Additionally or alternatively, the AV/ADAS system may modify the vehicle-based operation when a deviation between an output of the image sensor model and the image sensor 320 in excess of a predetermined threshold value is detected by modifying a sensor-weighting system implemented by the AV/ADAS system. For example, the image sensor 320 may be from among a suite of sensors, which may include additional image sensors as well as other sensor types (e.g. radar, lidar, etc.) that are implemented via the AV/ADAS system to detect and/or classify objects during vehicle operation. This “sensor fusion” technique may include applying different weights to the images and/or data acquired via each of these sensors to perform such determinations. For instance, images acquired via front-facing cameras may be given more weight than side-facing cameras for detecting close objects, as the latter may acquire images that are more prone to being blurred. Thus, the AV/ADAS system may modify the vehicle-based operation when the output of the image sensor model and the image sensor 320 in excess of a predetermined threshold value is detected by further reducing the weighting of the images acquired via the image sensor 320 compared to other sensors in the vehicle 100 when performing a machine vision object or feature classification process.

Additionally or alternatively, and as noted above, sensor fusion techniques (e.g. the PGF system as noted herein) may leverage a redundancy approach. Such redundancy approaches may, for instance, implement data streams of different sensors that are received, with an agreement between these different sensors (and optionally other data sources such as the REM map data for instance) being leveraged to make decisions and/or determine the vehicle-based functions. In other cases, for example, when safety constraints are involved, a single input type may be utilized according to such a redundancy approach. In any event, when such redundancy approaches are utilized, the AV/ADAS system may compare any suitable metrics that are derived from the CDP data to determine whether there is an agreement between the redundant systems and/or which redundant system output should be leveraged for use with the CV algorithms. For example, the safety system 200 may compare, for each separate system, an expected contrast detection of an object in a scene to the CDP probability output from that particular image sensor model and/or derived from the image sensor performance profile dataset. This data may then be used to identify which redundant system is more reliable and/or whether an agreement is reached between the two different systems, as the case may be.

As yet another example, the AV/ADAS system may modify the vehicle-based operation when a deviation between an output of the image sensor model and the image sensor 320 in excess of a predetermined threshold value is detected by modifying a parameter of the safety driving model (SDM). Again, the SDM parameters of the vehicle 100 may be implemented by the vehicle to navigate an environment, and thus may define parameters such as a minimum following distance, a maximum lateral distance, a maximum speed, etc. Thus, the modification of the vehicle-based operation may include, for instance, adjusting one or more such SDM parameters to compensate for the unreliability of the currently-acquired images via the image sensor 320. This may include temporarily increasing the minimum following distance, decreasing the maximum speed, etc.

### EXAMPLES

The following examples pertain to further aspects.

An example (e.g. example 1) is directed to a method for profiling an image sensor for use in a vehicle, comprising: receiving, from an image sensor, a plurality of images including a predetermined pattern; controlling a light source to adjust an illumination of the predetermined pattern at a plurality of different light levels; controlling the image sensor to adjust an exposure value; performing, for each one of the plurality of images, a contrast detection probability (CDP) measurement in accordance with a predetermined contrast target and a predetermined confidence interval, wherein the CDP measurement is repeated for each one of the plurality of images for different light levels of the predetermined pattern and different exposure values of the image sensor to generate an image sensor performance profile dataset that provides CDP measurements for different exposure values and different light levels; generating, using the image sensor performance profile dataset, an image sensor model; and modifying a vehicle-based operation based upon an output of the image sensor model.

Another example (e.g. example 2) relates to a previously-described example (e.g. example 1), wherein the image sensor is configured to acquire one or more images during operation of the vehicle, and wherein the modifying the vehicle-based operation comprises adjusting a machine vision based object or feature classification process that is performed using the acquired one or more images.

Another example (e.g. example 3) relates to a previously-described example (e.g. any combination of one or more of examples 1-2), wherein the adjusting the machine vision based object or feature classification process is based upon a comparison of an output of the image sensor model and an output of the image sensor model under the same conditions.

Another example (e.g. example 4) relates to a previously-described example (e.g. any combination of one or more of examples 1-3), wherein the adjusting the machine vision based object or feature classification process is based upon a location of the object or feature in the acquired one or more images, an exposure value of the image sensor when the one or more images were acquired, and a light level when the one or more images were acquired.

Another example (e.g. example 5) relates to a previously-described example (e.g. any combination of one or more of examples 1-4), wherein the modifying the vehicle-based operation comprises modifying a weighting of one or more images acquired by the image sensor during vehicle operation compared to other sensors in the vehicle to perform a machine vision object or feature classification process.

Another example (e.g. example 6) relates to a previously-described example (e.g. any combination of one or more of examples 1-5), wherein the modifying the vehicle-based operation comprises modifying a parameter of a safety driving model (SDM) parameter that is implemented by the vehicle to navigate an environment.

Another example (e.g. example 7) relates to a previously-described example (e.g. any combination of one or more of examples 1-6), wherein the CDP measurement is repeated for each one of a plurality of different predetermined confidence intervals to generate the image sensor performance dataset to provide CDP measurements for different light levels, exposure values, and confidence intervals.

Another example (e.g. example 8) relates to a previously-described example (e.g. any combination of one or more of examples 1-7), wherein the CDP measurement is repeated for each one of a plurality of different predetermined target contrasts to generate the image sensor performance dataset to provide CDP measurements for different light levels, exposure values, confidence intervals, and target contrasts.

Another example (e.g. example 9) relates to a previously-described example (e.g. any combination of one or more of examples 1-8), wherein the contrast detection probability (CDP) measurement is performed by selecting a subset of pixel pair combinations within each one of the plurality of images having a brightness level difference with respect to one another that is within a predetermined threshold deviation of the predetermined contrast target.

Another example (e.g. example 10) relates to a previously-described example (e.g. any combination of one or more of examples 1-9), further comprising: performing, for each one of the plurality of images, a color ratio measurement by calculating averaging color values of pixels contained within different portions of the predetermined pattern to provide, for each of the different portions, an average color value for each one a set of different colors, and calculating a ratio of each combination of the average color value for each one the set of different colors; and repeating the color ratio measurement for each one of the plurality of images for different light levels of the predetermined pattern and different exposure values of the image sensor to generate the image sensor performance dataset to further provide color ratio data for different light levels and exposure values.

An example (e.g. example 11) is directed to a computing device for profiling an image sensor for use in a vehicle, comprising: a memory configured to store instructions; and processing circuitry configured to execute the instructions stored in the memory to cause the computing device to: receive, from an image sensor, a plurality of images including a predetermined pattern; control a light source to adjust an illumination of the predetermined pattern at a plurality of different light levels; control the image sensor to adjust an exposure value; perform, for each one of the plurality of images, a contrast detection probability (CDP) measurement in accordance with a predetermined contrast target and a predetermined confidence interval, wherein the CDP measurement is repeated for each one of the plurality of images for different light levels of the predetermined pattern and different exposure values of the image sensor to generate an image sensor performance profile dataset that provides CDP measurements for different exposure values and different light levels; and generate, using the image sensor performance profile dataset, an image sensor model, wherein the image sensor model is configured to output data to cause modification of a vehicle-based operation.

Another example (e.g. example 12) relates to a previously-described example (e.g. example 11), wherein the image sensor is configured to acquire one or more images during operation of the vehicle, and wherein the modification of the vehicle-based operation comprises adjusting a machine vision based object or feature classification process that is performed using the acquired one or more images.

Another example (e.g. example 13) relates to a previously-described example (e.g. any combination of one or more of examples 11-12), wherein the adjusting the machine vision based object or feature classification process is based upon a comparison of an output of the image sensor model and an output of the image sensor model under the same conditions.

Another example (e.g. example 14) relates to a previously-described example (e.g. any combination of one or more of examples 11-13), wherein the adjusting the machine vision based object or feature classification process is based upon a location of the object or feature in the acquired one or more images, an exposure value of the image sensor when the one or more images were acquired, and a light level when the one or more images were acquired.

Another example (e.g. example 15) relates to a previously-described example (e.g. any combination of one or more of examples 11-14), wherein the modifying the vehicle-based operation comprises modifying a weighting of one or more images acquired by the image sensor during vehicle operation compared to other sensors in the vehicle to perform a machine vision object or feature classification process.

Another example (e.g. example 16) relates to a previously-described example (e.g. any combination of one or more of examples 11-15), wherein the modifying the vehicle-based operation comprises modifying a parameter of a safety driving model (SDM) parameter that is implemented by the vehicle to navigate an environment.

Another example (e.g. example 17) relates to a previously-described example (e.g. any combination of one or more of examples 11-16), wherein the processing circuitry is configured to repeat the CDP measurement for each one of a plurality of different predetermined confidence intervals to generate the image sensor performance dataset to provide CDP measurements for different light levels, exposure values, and confidence intervals.

Another example (e.g. example 18) relates to a previously-described example (e.g. any combination of one or more of examples 11-17), wherein the processing circuitry is configured to repeat the CDP measurement for each one of a plurality of different predetermined target contrasts to generate the image sensor performance dataset to provide CDP measurements for different light levels, exposure values, confidence intervals, and target contrasts.

Another example (e.g. example 19) relates to a previously-described example (e.g. any combination of one or more of examples 11-18), wherein the processing circuitry is configured to perform the contrast detection probability (CDP) measurement by selecting a subset of pixel pair combinations within each one of the plurality of images having a brightness level difference with respect to one another that is within a predetermined threshold deviation of the predetermined contrast target.

Another example (e.g. example 20) relates to a previously-described example (e.g. any combination of one or more of examples 11-19), wherein the processing circuitry is configured to: perform, for each one of the plurality of images, a color ratio measurement by calculating averaging color values of pixels contained within different portions of the predetermined pattern to provide, for each of the different portions, an average color value for each one a set of different colors, and calculating a ratio of each combination of the average color value for each one the set of different colors; and repeat the color ratio measurement for each one of the plurality of images for different light levels of the predetermined pattern and different exposure values of the image sensor to generate the image sensor performance dataset to further provide color ratio data for different light levels and exposure values.

An apparatus as shown and described.

A method as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

What is claimed is:

1. A method for profiling an image sensor for use in a vehicle, comprising:
receiving, from an image sensor, a plurality of images including a predetermined pattern;
controlling a light source to adjust an illumination of the predetermined pattern at a plurality of different light levels;
controlling the image sensor to adjust an exposure value;
performing, for each one of the plurality of images, a contrast detection probability (CDP) measurement in accordance with a predetermined contrast target and a predetermined confidence interval,
wherein the CDP measurement is repeated for each one of the plurality of images for different light levels of the predetermined pattern and different exposure values of the image sensor to generate an image sensor performance profile dataset that provides CDP measurements for different exposure values and different light levels;
generating, using the image sensor performance profile dataset, an image sensor model; and
modifying a vehicle-based operation based upon an output of the image sensor model.

2. The method of claim 1, wherein the image sensor is configured to acquire one or more images during operation of the vehicle, and
wherein the modifying the vehicle-based operation comprises adjusting a machine vision based object or feature classification process that is performed using the acquired one or more images.

3. The method of claim 2, wherein the adjusting the machine vision based object or feature classification process is based upon a comparison of an output of the image sensor model and an output of the image sensor model under the same conditions.

4. The method of claim 2, wherein the adjusting the machine vision based object or feature classification process is based upon a location of the object or feature in the acquired one or more images, an exposure value of the image sensor when the one or more images were acquired, and a light level when the one or more images were acquired.

5. The method of claim 1, wherein the modifying the vehicle-based operation comprises modifying a weighting of one or more images acquired by the image sensor during vehicle operation compared to other sensors in the vehicle to perform a machine vision object or feature classification process.

6. The method of claim 1, wherein the modifying the vehicle-based operation comprises modifying a parameter of a safety driving model (SDM) parameter that is implemented by the vehicle to navigate an environment.

7. The method of claim 1, wherein the CDP measurement is repeated for each one of a plurality of different predetermined confidence intervals to generate the image sensor performance dataset to provide CDP measurements for different light levels, exposure values, and confidence intervals.

8. The method of claim 7, wherein the CDP measurement is repeated for each one of a plurality of different predetermined target contrasts to generate the image sensor performance dataset to provide CDP measurements for different light levels, exposure values, confidence intervals, and target contrasts.

9. The method of claim 1, wherein the contrast detection probability (CDP) measurement is performed by selecting a subset of pixel pair combinations within each one of the plurality of images having a brightness level difference with respect to one another that is within a predetermined threshold deviation of the predetermined contrast target.

10. The method of claim 1, further comprising:
performing, for each one of the plurality of images, a color ratio measurement by calculating averaging color values of pixels contained within different portions of the predetermined pattern to provide, for each of the different portions, an average color value for each one a set of different colors, and calculating a ratio of each combination of the average color value for each one the set of different colors; and
repeating the color ratio measurement for each one of the plurality of images for different light levels of the predetermined pattern and different exposure values of the image sensor to generate the image sensor performance dataset to further provide color ratio data for different light levels and exposure values.

11. A computing device for profiling an image sensor for use in a vehicle, comprising:
a memory configured to store instructions; and
processing circuitry configured to execute the instructions stored in the memory to cause the computing device to:
receive, from an image sensor, a plurality of images including a predetermined pattern;
control a light source to adjust an illumination of the predetermined pattern at a plurality of different light levels;
control the image sensor to adjust an exposure value;
perform, for each one of the plurality of images, a contrast detection probability (CDP) measurement in accordance with a predetermined contrast target and a predetermined confidence interval,
wherein the CDP measurement is repeated for each one of the plurality of images for different light levels of the predetermined pattern and different exposure values of the image sensor to generate an image sensor performance profile dataset that provides CDP measurements for different exposure values and different light levels; and
generate, using the image sensor performance profile dataset, an image sensor model,
wherein the image sensor model is configured to output data to cause modification of a vehicle-based operation.

12. The computing device of claim 11, wherein the image sensor is configured to acquire one or more images during operation of the vehicle, and
wherein the modification of the vehicle-based operation comprises adjusting a machine vision based object or feature classification process that is performed using the acquired one or more images.

13. The computing device of claim 12, wherein the adjusting the machine vision based object or feature classification process is based upon a comparison of an output of the image sensor model and an output of the image sensor model under the same conditions.

14. The computing device of claim 12, wherein the adjusting the machine vision based object or feature classification process is based upon a location of the object or feature in the acquired one or more images, an exposure value of the image sensor when the one or more images were acquired, and a light level when the one or more images were acquired.

15. The computing device of claim 11, wherein the modifying the vehicle-based operation comprises modifying a weighting of one or more images acquired by the image sensor during vehicle operation compared to other sensors in the vehicle to perform a machine vision object or feature classification process.

16. The computing device of claim 11, wherein the modifying the vehicle-based operation comprises modifying a parameter of a safety driving model (SDM) parameter that is implemented by the vehicle to navigate an environment.

17. The computing device of claim 11, wherein the processing circuitry is configured to repeat the CDP measurement for each one of a plurality of different predetermined confidence intervals to generate the image sensor performance dataset to provide CDP measurements for different light levels, exposure values, and confidence intervals.

18. The computing device of claim 17, wherein the processing circuitry is configured to repeat the CDP measurement for each one of a plurality of different predetermined target contrasts to generate the image sensor performance dataset to provide CDP measurements for different light levels, exposure values, confidence intervals, and target contrasts.

19. The computing device of claim 11, wherein the processing circuitry is configured to perform the contrast detection probability (CDP) measurement by selecting a subset of pixel pair combinations within each one of the plurality of images having a brightness level difference with respect to one another that is within a predetermined threshold deviation of the predetermined contrast target.

20. The computing device of claim 11, wherein the processing circuitry is configured to:
perform, for each one of the plurality of images, a color ratio measurement by calculating averaging color values of pixels contained within different portions of the predetermined pattern to provide, for each of the different portions, an average color value for each one a set of different colors, and calculating a ratio of each combination of the average color value for each one the set of different colors; and
repeat the color ratio measurement for each one of the plurality of images for different light levels of the predetermined pattern and different exposure values of the image sensor to generate the image sensor performance dataset to further provide color ratio data for different light levels and exposure values.
